(19) United States
(12) Patent Application Publication
(10) Pub. No.: US 2011/0159336 A1
(43) Pub. Date: Jun. 30, 2011

(54) BATTERY SYSTEM AND ELECTRIC VEHICLE INCLUDING THE SAME

(75) Inventors: Kazumi OHKURA, Nara-City (JP); Kenji TAGUCHI, Hirakata-City (JP)

(73) Assignee: SANYO ELECTRIC CO., LTD., Moriguchi-City (JP)

(21) Appl. No.: 12/975,554

(22) Filed: Dec. 22, 2010

(30) Foreign Application Priority Data
Dec. 25, 2009 (JP) 2009-295897
Dec. 8, 2010 (JP) 2010-273526

(51) Int. Cl. H01M 2/10

(52) U.S. Cl. 429/99

(57) ABSTRACT

A battery system includes battery modules. Each of the battery modules has an end surface member formed of a rectangular plate. The battery modules are arranged to form a line such that the end surface member of the battery module comes in contact with the end surface member of the battery module. In this state, the end surface member of the battery module is joined to the end surface member of the battery module by screws and nuts.

### BACKGROUND OF THE INVENTION

1. Field of the Invention

The present invention relates to a battery system including battery modules and an electric vehicle including the same.

2. Description of the Background Art

In a battery system used as a stationary electrical storage device, a driving source of a movable object such as an electric automobile or the like, a plurality of chargeable and dischargeable battery modules are provided for supplying a given driving force. Each of the battery modules has such a configuration that a plurality of batteries (battery cells) are connected in series, for example.

In a secondary battery module disclosed in JP 2006-156392 A, a plurality of battery cells are stacked, and a pair of end plates is arranged on outermost sides of the plurality of battery cells. Each end plate includes a flat plate member that is in close contact with one surface of the battery cell, and a plurality of fastening members formed to project from the flat plate member. A plurality of fastening rods are inserted in the fastening members, so that the pair of end plates are fastened to each other.

The end plates are formed such that each flat plate member has a smaller thickness than the fastening member in order to reduce the weight of the battery module and prevent the fastening members of the end plates from being deformed and damaged. Alternatively, only the fastening members are formed of a material having higher strength than the flat plate members in order to suppress an increase in manufacturing cost of the battery module and prevent the fastening members of the end plates from being deformed and damaged.

However, the battery cells have the property of expanding due to repetitive charge/discharge for a long period of time. Therefore, the flat plate members of the end plates may be deformed and damaged in the battery module of JP 2006-156392 A.

When the thickness of each of the flat plate members is increased in order to prevent the flat plate members of the end plates of JP 2006-156392 A from being deformed and damaged, the size and weight of the battery module is increased. When the flat plate members are formed of a higher-strength material, the manufacturing cost of the battery module is increased.

### BRIEF SUMMARY OF THE INVENTION

An object of the present invention is to provide a battery system that can be reduced in size and weight without an increase in manufacturing cost, and an electric vehicle including the same.

(1) According to an aspect of the present invention, a battery system includes a first battery block including a plurality of first battery cells that are stacked, a second battery block including a plurality of second battery cells that are stacked, a first end surface member arranged so as to be stacked on the first battery cell positioned at one end of the first battery block in a direction in which the plurality of first battery cells are stacked, and a second end surface member arranged so as to be stacked on the second battery cell positioned at one end of the second battery block in a direction in which the plurality of second battery cells are stacked, wherein the first battery block and the second battery block are fixed to each other with the first end surface member and the second end surface member being in contact with each other.

In the battery system, the first end surface member is arranged so as to be stacked on the first battery cell positioned at the one end of the first battery block in the direction in which the plurality of first battery cells are stacked. The second end surface member is arranged so as to be stacked on the second battery cell positioned at the one end of the second battery block in the direction in which the plurality of second battery cells are stacked. The first battery block and the second battery block are fixed to each other with the first end surface member and the second end surface member being in contact with each other.

In this case, even though the plurality of first battery cells of the first battery block and the plurality of second battery cells of the second battery block expand, stress exerted on the first end surface member and stress exerted on the second end surface member cancel each other out. Therefore, the first and second end surface members are sufficiently prevented from being deformed and damaged even when the thicknesses of the first and second end surface members are small. This allows for reduced size and weight of the battery system.

The first and second end surface members are prevented from being deformed and damaged even when the first and second end surface members are formed of a low-strength material. This suppresses an increase in manufacturing cost of the battery system.

(2) The battery system may further include a casing that accommodates the first and second battery blocks, wherein the first and second battery blocks may be fixed to the casing with the first end surface member and the second end surface member being in contact with each other.

In this case, the first and second battery blocks are fixed to the casing, thereby causing the first end surface member and the second end surface member to be joined to each other while being in contact with each other. Such a configuration eliminates the need for a joining member for joining the first end surface member and the second end surface member to each other. This suppresses higher component cost and an increased number of assembly steps.

(3) The battery system may further include a joining member that joins the first end surface member and the second end surface member to each other.

In this case, the first end surface member and the second end surface member are joined to each other by the joining member. Thus, the first battery block and the second battery block are fixed to each other with the first end surface member and the second end surface member being in contact with each other. Such a configuration allows the first and second end surface members to be reliably fixed to the first and second battery blocks, respectively.

(4) The first and second end surface members may have respective holes, and the joining member may include a screw member to be inserted in the respective holes of the first and second end surface members.

In this case, the screw member is inserted in the respective holes of the first and second end surface members, thereby easily and reliably joining the first end surface member and the second end surface member to each other.

(5) The joining member may include a sandwiching member that joins the first and second end surface members to each other by sandwiching the first and second end surface members.

In this case, the sandwiching member sandwiches the first and second end surface members, thereby easily and reliably joining the first end surface member and the second end surface member to each other.

(6) The joining member may include a latch member that is provided in the first end surface member and that latches the second end surface member.

In this case, the latch member of the first end surface member latches the second end surface member, thereby easily and reliably joining the first end surface member and the second end surface member to each other.

(7) The battery system may further include a third end surface member arranged so as to be stacked on the first battery cell positioned at the other end on the opposite side to the one end of the first battery block in the direction in which the plurality of first battery cells of the first battery block are stacked, and a fourth end surface member arranged so as to be stacked on the second battery cell positioned at the other end on the opposite side to the one end of the second battery block in the direction in which the plurality of second battery cells of the second battery block are stacked, wherein the plurality of first battery cells of the first battery block may be integrally fixed by being sandwiched between the first end surface member and the third end surface member, and the plurality of second battery cells of the second battery block may be integrally fixed by being sandwiched between the second end surface member and the fourth end surface member.

In this case, the plurality of first battery cells of the first battery block are reliably fixed by the first and third end surface members. The plurality of second battery cells of the second battery block are reliably fixed by the second and fourth end surface members.

(8) A thickness of the third end surface member may be larger than a thickness of the first end surface member, and a thickness of the fourth end surface member may be larger than a thickness of the second end surface member.

In this case, the third end surface member has the larger thickness than the first end surface member. Therefore, even though the plurality of first battery cells of the first battery block expand, the third end surface member is sufficiently prevented from being deformed and damaged. The fourth end surface member has the larger thickness than the second end surface member. Therefore, even though the plurality of second battery cells of the second battery block expand, the fourth end surface member is sufficiently prevented from being deformed and damaged.

(9) The battery system may further include a casing that accommodates the first and second battery blocks, wherein the third and fourth end surface members are fixed to the casing.

In this case, the third and fourth end surface members are fixed to the casing of the battery system, so that the first and second battery blocks are more reliably joined with the first end surface member and the second end surface member being in contact with each other.

(10) According to another aspect of the present invention, an electric vehicle includes the battery system according to the one aspect of the present invention, a motor driven by electric power supplied from the first battery block and the second battery block of the battery system, and a drive wheel rotated by a torque generated by the motor.

In the electric vehicle, the motor is driven by the electric power supplied from the first battery block and the second battery block. The torque of the motor rotates the drive wheel, thereby moving the electric vehicle.

The battery system according to the one aspect of the present invention is applied to the electric vehicle, thus allowing for reduction in size and weight of the electric vehicle. Moreover, an increase in manufacturing cost of the electric vehicle can be suppressed.

According to the present invention, the battery system can be reduced in size and weight without an increase in manufacturing cost.

Other features, elements, characteristics, and advantages of the present invention will become more apparent from the following description of preferred embodiments of the present invention with reference to the attached drawings.

### BRIEF DESCRIPTION OF THE SEVERAL VIEWS OF THE DRAWINGS

FIG. 1 is a block diagram showing the schematic configuration of a battery system according to a first embodiment;

FIG. 2 is an external perspective view of a battery module;

FIG. 3 is a plan view of the battery module;

FIG. 4 is an end view of the battery module;

FIG. 5 is an external perspective view of a battery cell holding member;

FIG. 6 shows a schematic side view and a schematic sectional view of a separator;

FIG. 7 is a schematic side view showing a plurality of separators each arranged between a plurality of battery cells;

FIG. 8 is an external perspective view of bus bars;

FIG. 9 is an external perspective view of FPC boards to which a plurality of bus bars and a plurality of PTC elements are attached;

FIG. 10 is a schematic plan view for explaining connection between the bus bars and a detecting circuit;

FIG. 11 is a schematic plan view showing one example of arrangement of a plurality of battery modules in the battery system;

FIG. 12 is an enlarged plan view of a portion where the battery modules are joined;

FIG. 13 is an external perspective view of a battery cell holding member in a second embodiment;

FIG. 14 is an enlarged plan view of a portion where battery modules are joined in a battery system according to the second embodiment;

FIG. 15 is an external perspective view of a battery cell holding member in a third embodiment;

FIG. 16 is an enlarged side view of a portion where battery modules are joined in a battery system according to the third embodiment;

FIG. 17 is an external perspective view of a battery cell holding member in a fourth embodiment;

FIG. 18 is an enlarged plan view of a portion where battery modules are joined in a battery system according to the fourth embodiment;

FIG. 19 is an external perspective view of battery cell holding members in a fifth embodiment;

FIG. 20 is a vertical sectional view of a portion where battery modules are joined in a battery system according to the fifth embodiment;

FIG. 21 is an external perspective view of battery cell holding members in a sixth embodiment;

FIG. 22 is a vertical sectional view of a portion where battery modules are joined in a battery system according to the sixth embodiment;

FIG. 23 is an external perspective view of battery cell holding members in a seventh embodiment;

FIG. 24 is a vertical sectional view of a portion where battery modules are joined in a battery system according to the seventh embodiment;

FIG. 25 is an external perspective view of battery cell holding members in an eighth embodiment;

FIG. 26 is a vertical sectional view of a portion where battery modules are joined in a battery system according to the eighth embodiment;

FIG. 27 is an external perspective view of battery cell holding members in a ninth embodiment;

FIG. 28 is a vertical sectional view of a portion where battery modules are joined in a battery system according to the ninth embodiment;

FIG. 29 is an external perspective view of battery cell holding members in a tenth embodiment;

FIG. 30 is an enlarged plan view of portions where battery modules are joined in a battery system according to the tenth embodiment;

FIG. 31 is an external perspective view showing another example of the battery cell holding members in the tenth embodiment;

FIG. 32 is a an external perspective view of an end surface member in an eleventh embodiment;

FIG. 33 is a side view of a portion where battery modules are joined in a battery system according to the eleventh embodiment;

FIG. 34 is an external perspective view of an end surface member in a twelfth embodiment;

FIG. 35 is a side view of a portion where battery modules are joined in a battery system according to the twelfth embodiment;

FIG. 36 is a schematic plan view showing one example of connection and wiring of battery modules in a battery system according to a thirteenth embodiment;

FIG. 37 is a block diagram showing the configuration of an electric automobile including the battery system;

FIG. 38 is an external perspective view of a laminate type battery cell;

FIG. 39 is an exploded perspective view of the laminate type battery cell of FIG. 38; and

FIG. 40 is a side view of a battery module using laminate type battery cells of FIG. 38.

### DETAILED DESCRIPTION OF THE INVENTION

### [1] First Embodiment

Hereinafter, description will be made of a battery system according to a first embodiment by referring to the drawings. The battery system according to the present embodiment is mounted on an electric vehicle (an electric automobile, for example) using electric power as a driving source.

(1) Configuration of the Battery System

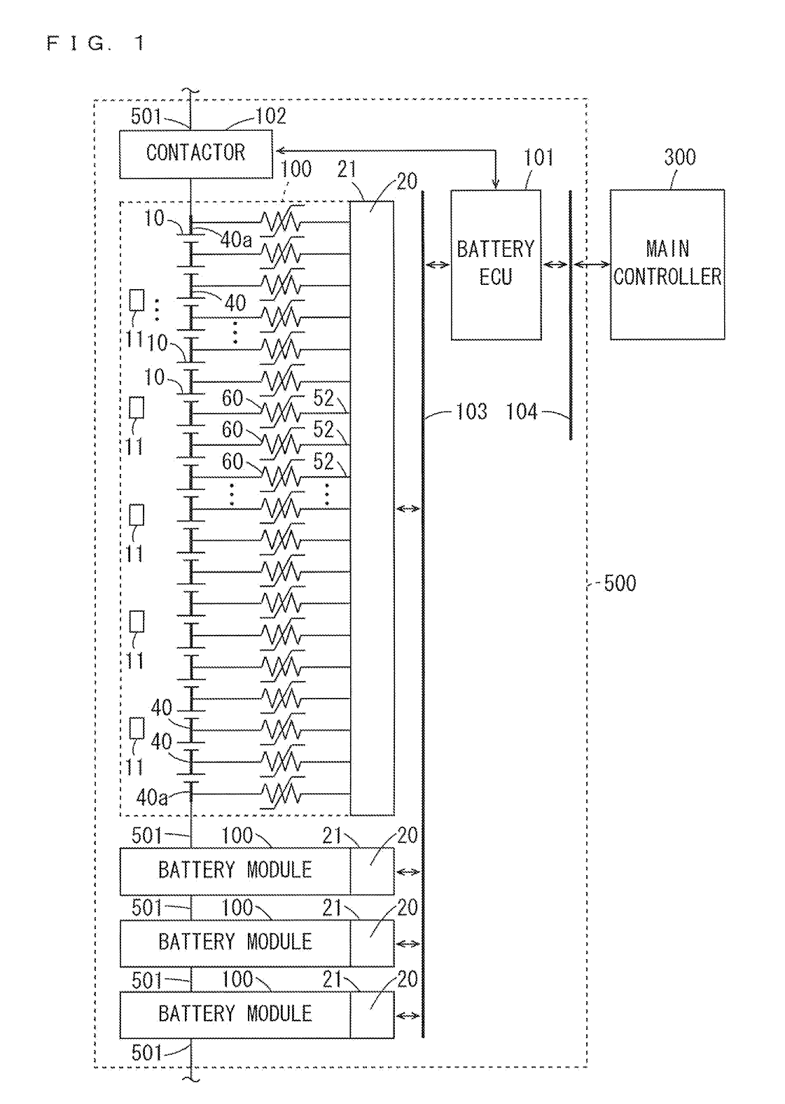

FIG. 1 is a block diagram showing the configuration of the battery system according to the first embodiment. As illustrated in FIG. 1, the battery system 500 includes a plurality of battery modules 100, a battery ECU (Electronic Control Unit) 101 and a contactor 102, and is connected to a main controller 300 in the electric vehicle via a bus 104.

The plurality of battery modules 100 are connected to one another via power supply lines 501. Each of the battery modules 100 includes a plurality of (eighteen in this example) battery cells 10, a plurality of (five in this example) thermistors 11, and a rigid printed circuit board (hereinafter abbreviated as a printed circuit board) 21.

In each of the battery module 100, the plurality of battery cells 10 are integrally arranged adjacent to one another, and are connected in series through a plurality of bus bars 40. Each battery cell 10 is a secondary battery such as a lithium-ion battery or a nickel metal hydride battery.

The battery cells 10 arranged at both ends of each of the battery modules 100 are connected to the power supply lines 501 through bus bars 40a, respectively. In this manner, all the battery cells 10 of the plurality of battery modules 100 are connected in series in the battery system 500. The power supply lines 501 pulled out from the battery system 500 are connected to a load such as a motor of the electric vehicle.

A detecting circuit 20 is mounted on the printed circuit board 21. The detecting circuit 20 is electrically connected to all the bus bars 40, 40a of the corresponding battery module 100 through conductor lines 52 and PTC (Positive Temperature Coefficient) elements 60. The printed circuit board 21 is electrically connected to all the thermistors 11 of the corresponding battery module 100.

In the present embodiment, the detecting circuit 20 detects a voltage between terminals of each battery cell 10 by detecting potential differences among the bus bars 40, 40a connecting the plurality of battery cells 10. The detecting circuit 20 functions as a voltage detector. Details will be described below.

Also, the detecting circuit 20 detects a temperature at a given portion of each battery module 100 based on signals output from the plurality of thermistors 11. In this manner, the detecting circuit 20 also functions as a temperature detector.

In the present embodiment, at least one bus bar 40 of the plurality of bus bars 40 of each battery module 100 is used as a shunt resistance for current detection. The detecting circuit 20 detects a current flowing through each battery module 100 by detecting a voltage at both ends of the bus bar 40 used as the shunt resistance. In this manner, the detecting circuit 20 functions as a current detector.

The PTC element 60 has such resistance temperature characteristics as to have a resistance value rapidly increasing when its temperature exceeds a certain value. Therefore, if a short occurs in the detecting circuit 20 and the conductor line 52, for example, the temperature of the PTC element 60 that rises because of the current flowing through the short-circuited path causes the resistance value of the PTC element 60 to increase. Accordingly, a large current is inhibited from flowing through the short-circuited path including the PTC element 60.

The detecting circuit 20 of each battery module 100 is connected to the battery ECU 101 via a bus 103. This causes the voltage, current and temperature detected by the detecting circuit 20 to be given to the battery ECU 101.

The battery ECU 101 calculates charged capacity of each battery cell 10 based on the voltage, current and temperature given from each detecting circuit 20, for example, and controls charge/discharge of each battery module based on the charged capacity. In addition, the battery ECU 101 detects abnormality of each battery module 100 based on the voltage, current and temperature given from each detecting circuit 20. The abnormality of the battery module 100 includes overdischarge, overcharge or abnormal temperature of the battery cells 10, for example.

The contactor 102 is inserted in the power supply line 501 connected to the battery module 100 at one end of the battery system 500. The battery ECU 101 turns off the contactor 102 when it detects the abnormality of the battery module 100. Since the current does not flow through the battery modules 100 in the case of an occurrence of the abnormality, the battery module 100 is prevented from being abnormally heated.

The battery ECU 101 is connected to the main controller 300 via the bus 104. The charged capacity of each battery cell 10 is given from the battery ECU 101 to the main controller 300. The main controller 300 controls power of the electric vehicle (a rotational speed of the motor, for example) based on the charged capacity. When the charged capacity of each battery module 100 decreases, the main controller 300 controls a power generating system, not shown, connected to the power supply line 501 to cause each battery module 100 to be charged.

The motor connected to the power supply line 501, for example, functions as the power generating system in the present embodiment. In this case, the motor converts electric power supplied from the battery system 500 into power for driving the drive wheel, which is not shown, at the time of acceleration of the electric vehicle. The motor generates regenerated electric power at the time of deceleration of the electric vehicle. The battery modules 100 are charged with the regenerated electric power.

(2) Details of the Battery Module

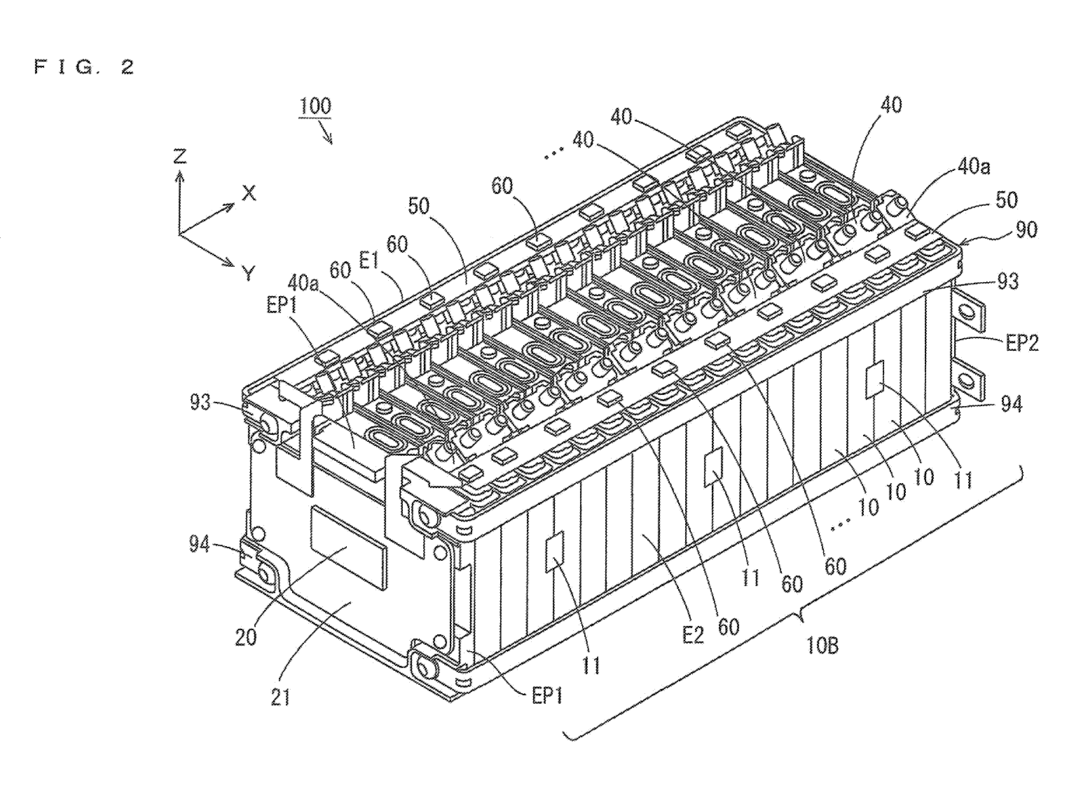

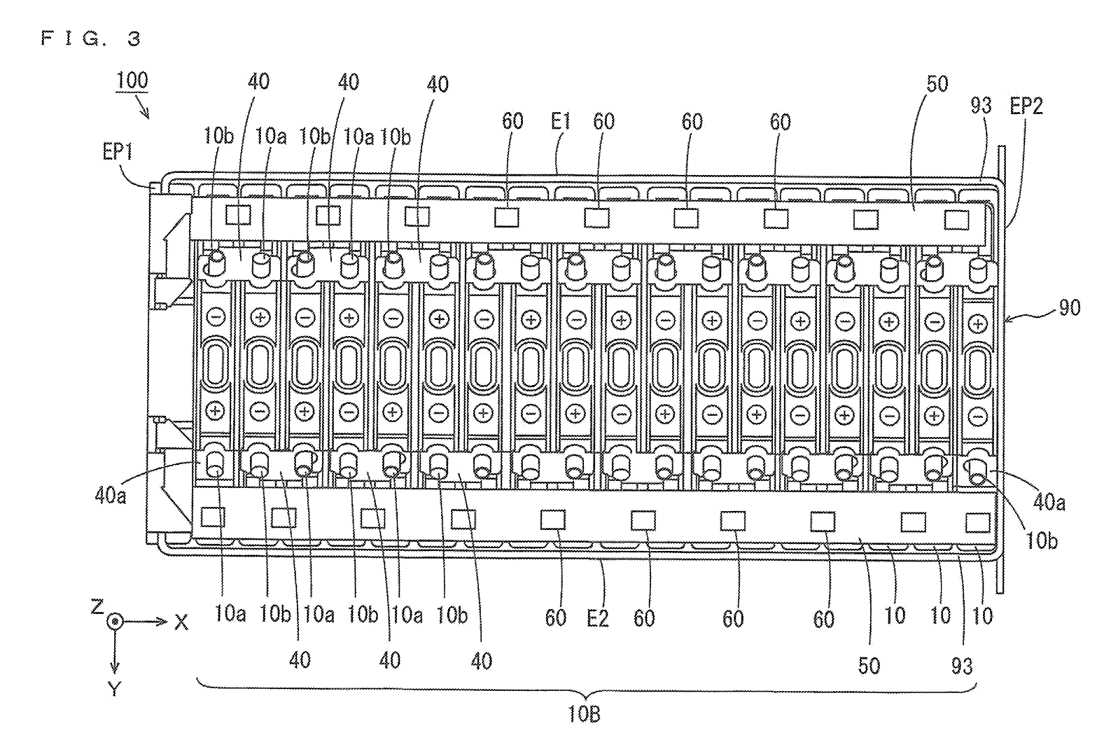

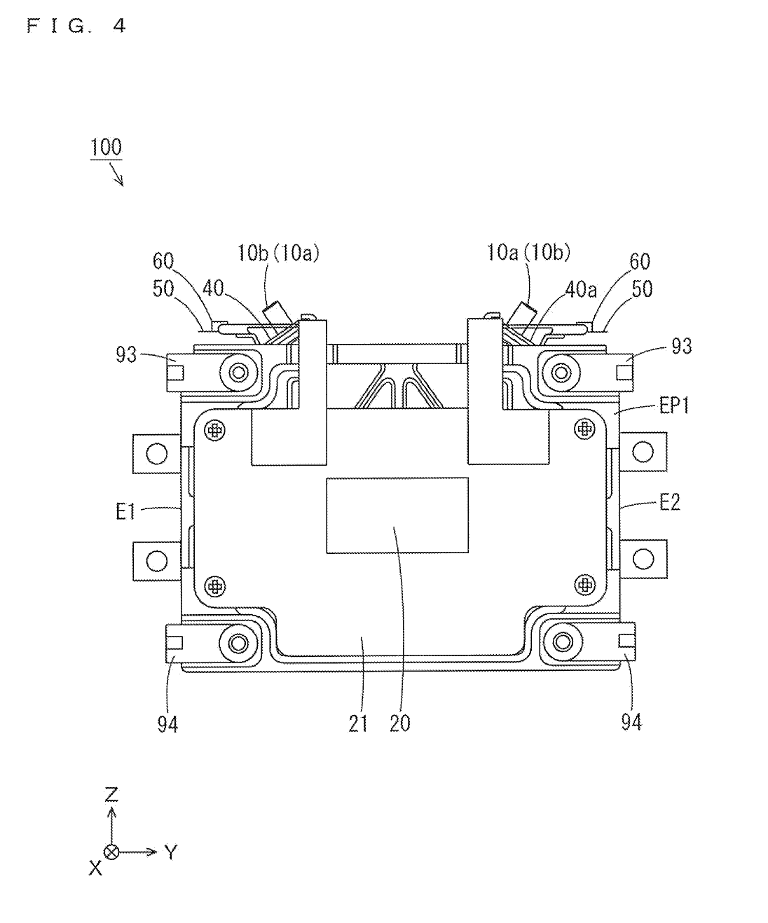

Description is made of details of the battery module 100. FIG. 2 is an external perspective view of the battery module 100, FIG. 3 is a plan view of the battery module 100, and FIG. 4 is an end view of the battery module 100.

In FIGS. 2 to 4, and FIGS. 9, 10 and 40 described below, three directions that are perpendicular to one another are defined as an X-direction, a Y-direction and a Z-direction as indicated by the arrows X, Y, Z. The X-direction and the Y-direction are parallel to a horizontal plane, and the Z-direction is perpendicular to the horizontal plane in this example. A direction in which the arrow Z points is the upward direction.

As shown in FIGS. 2 to 4, the plurality of battery cells 10 each having a flat and substantially rectangular parallelepiped shape are arranged to be stacked in the X-direction in the battery module 100. The plurality of battery cells 10 constitute a battery block 10B. In this state, the battery block 10B is integrally fixed by an end surface member EP1 and a battery cell holding member 90.

Here, surfaces of ends in the X-direction (the direction in which the battery cells 10 are stacked) of the battery block 10B, that is, outermost surfaces of the battery cells 10 arranged at both ends are referred to as end surfaces of the battery block 10B. One side surface of the battery block 10B along the Y-direction is referred to as a side surface E1, and the other side surface of the battery block 10B along the Y-direction is referred to as a side surface E2.

The end surface member EP1 is formed of a rectangular plate and stacked on the battery cell 10 arranged at the one end in the X-direction (the direction in which the battery cells 10 are stacked) of the battery block 10B. That is, the end surface member EP1 is arranged on one end surface of the battery block 10B. The printed circuit board 21 is mounted on the end surface member EP1.

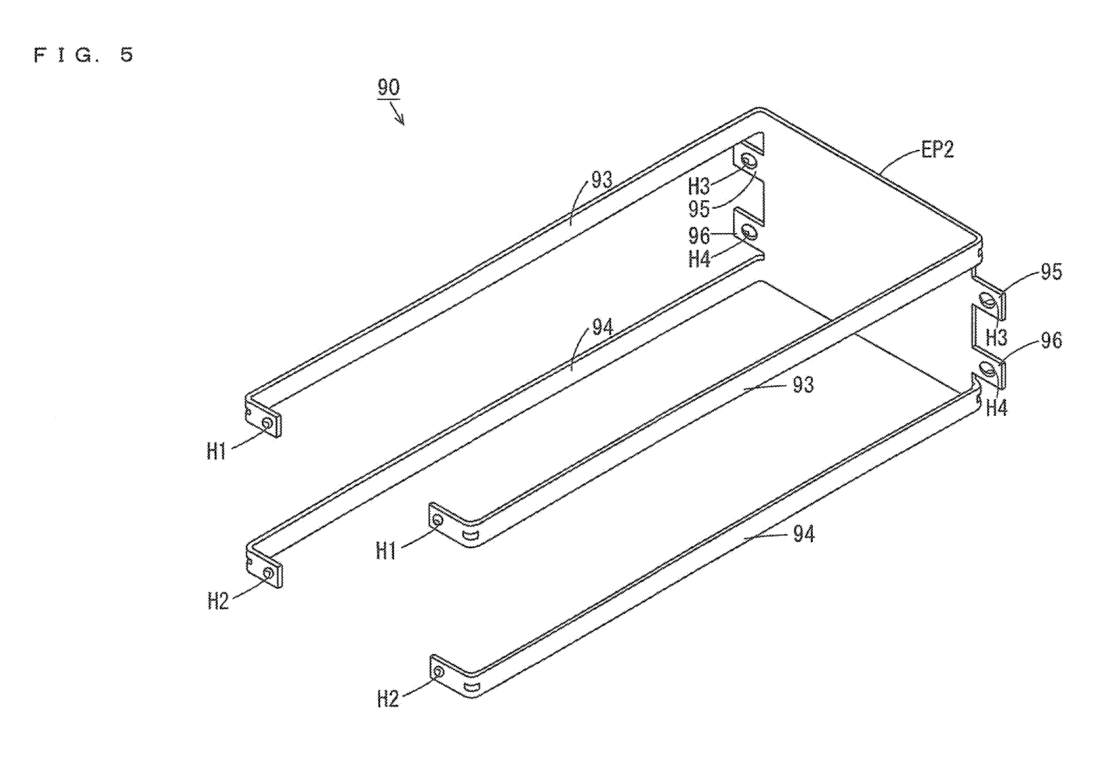

Description is made of details of the configuration of the battery cell holding member 90. FIG. 5 is an external perspective view of the battery cell holding member 90. As shown in FIG. 5, the battery cell holding member 90 is composed of an end surface member EP2, a pair of fixing members 93 and a pair of fixing member 94. The end surface member EP2 is formed of a rectangular plate. The pair of fixing members 93 is composed of bar-shaped plates, and formed to extend from upper ends on both lateral sides of the end surface member EP2 at a right angle to the end surface member EP2. The pair of fixing members 94 is composed of bar-shaped plates, and formed to extend from lower ends on the both lateral sides of the end surface member EP2 at a right angle to the end surface member EP2. The end surface member EP2 is formed of a metal or an alloy such as an aluminum alloy die casting, and the fixing members 93, 94 are each formed of a metal or an alloy such as a cold-rolled steel plate, for example. The thickness of the end surface member EP2 is smaller than that of the end surface member EP1 of FIG. 2. The thickness of the end surface member EP1 is larger than that of the end surface member EP2, thereby sufficiently preventing the end surface member EP1 from being deformed and damaged even though the plurality of battery cells 10 of the battery block 10B expand.

The tip of each fixing member 93 is bent inward at a right angle. A hole H1 is formed at the tip of each fixing member 93. The tip of each fixing member 94 is bent inward at a right angle. A hole H2 is formed at the tip of each fixing member 94.

A pair of fastening portions 95 and a pair of fastening portions 96 are formed to project from the both lateral sides of the end surface member EP2. A hole H3 is formed in each fastening portion 95. A hole H4 is formed in each fastening portion 96.

Returning to FIGS. 2 to 4, the end surface member EP2 of the battery cell holding member 90 is stacked on the battery cell 10 arranged at the other end in the X-direction (the direction in which the battery cells 10 are stacked) of the battery block 10B. That is, the end surface member EP2 is arranged on the other end surface of the battery block 10B.

Connection portions, to which the pair of fixing members 93 and the pair of fixing members 94 are connected, are formed at four corners of the end surface member EP1. Screws, for example, are inserted in the holes H1 (see FIG. 5) at the tips of the pair of fixing members 93, so that the tips of the pair of fixing members 93 are fixed to the upper connection portions of the end surface member EP1. Similarly, screws, for example, are inserted in the holes H2 (see FIG. 5) at the tips of the pair of fixing members 94, so that the tips of the pair of fixing members 94 are fixed to the lower connection portions of the end surface member EP1. Accordingly, the plurality of battery cells 10 are reliably fixed in an integrated manner while being stacked in the X-direction.

Here, each battery cell 10 has a plus electrode 10a and a minus electrode 10b that line up along the Y-direction on its upper surface. Each of the electrodes 10a, 10b is provided to be inclined and project upward (see FIG. 4).

In the following description, the battery cell 10 adjacent to the end surface member EP2 to the battery cell 10 adjacent to the end surface member EP1 to which the printed circuit board 21 is attached are referred to as a first battery cell 10 to an eighteenth battery cell 10.

In the battery module 100, the battery cells 10 are arranged such that the positional relationship between the plus electrode 10a and the minus electrode 10b of each battery cell 10 in the Y-direction is opposite to that of the adjacent battery cell 10, as shown in FIG. 3. One electrodes 10a, 10b of the plurality of battery cells 10 are arranged to form a line along the X-direction, and the other electrodes 10a, 10b of the plurality of battery cells 10 are arranged to form a line along the X-direction.

Thus, in two adjacent battery cells 10, the plus electrode 10a of one battery cell 10 is in close proximity to the minus electrode 10b of the other battery cell 10, and the minus electrode 10b of the one battery cell 10 is in close proximity to the plus electrode 10a of the other battery cell 10. In this state, the bus bar 40 is attached to the two electrodes being in close proximity to each other. This causes the plurality of battery cells 10 to be connected in series.

More specifically, the common bus bar 40 is attached to the plus electrode 10a of the first battery cell 10 and the minus electrode 10b of the second battery cell 10. The common bus bar 40 is attached to the plus electrode 10a of the second battery cell 10 and the minus electrode 10b of the third battery cell 10. Similarly, the common bus bar 40 is attached to the plus electrode 10a of each of the odd numbered battery cells 10 and the minus electrode 10b of each of the even numbered battery cells 10 adjacent thereto. The common bus bar 40 is attached to the plus electrode 10a of each of the even numbered battery cells 10 and the minus electrode 10b of each of the odd numbered battery cells 10 adjacent thereto.

The bus bar 40a for connecting the power supply line 501 from the exterior is attached to each of the minus electrode 10b of the first battery cell 10 and the plus electrode 10a of the eighteenth battery cell 10.

A long-sized flexible printed circuit board (hereinafter abbreviated as an FPC board) 50 extending in the X-direction is connected in common to the plurality of bus bars 40 on the side of one ends of the plurality of battery cells 10 in the Y-direction. Similarly, a long-sized FPC board 50 extending in the X-direction is connected in common to the plurality of bus bars 40, 40a on the side of the other ends of the plurality of battery cells 10 in the Y-direction.

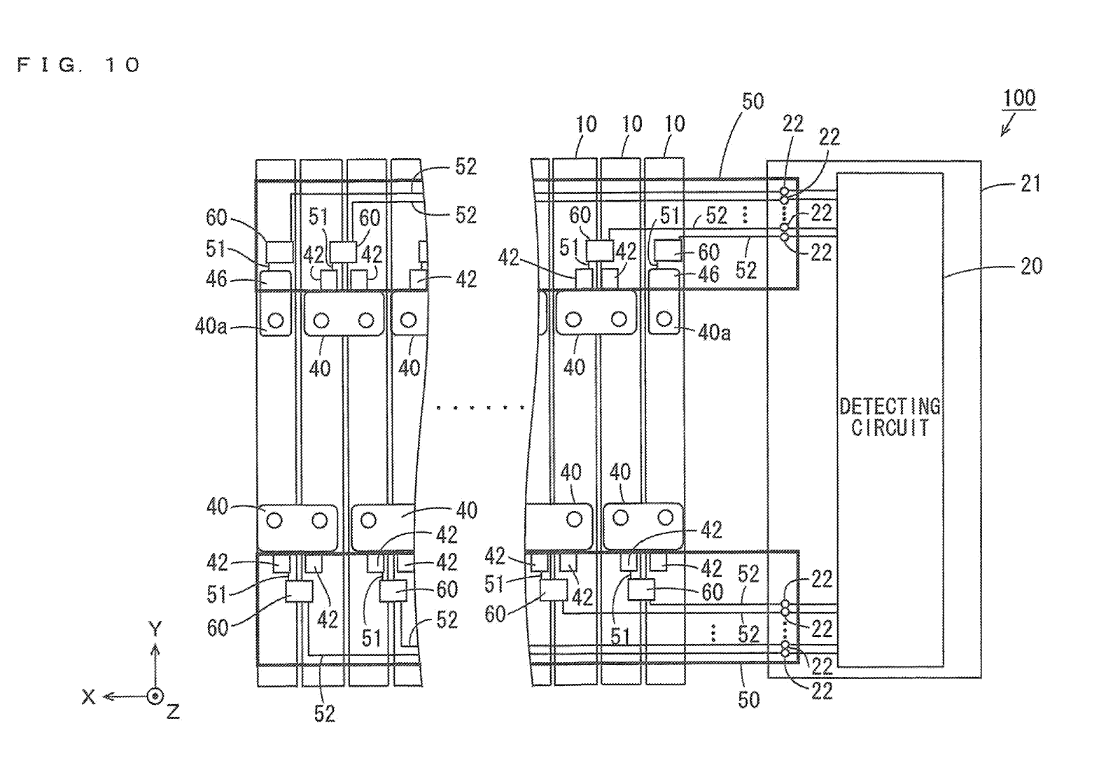

The FPC board 50 having bending characteristics and flexibility mainly includes a plurality of conductor lines (wiring traces) 51, 52 (see FIG. 10, described below) formed on an insulating layer. Examples of a material for the insulating layer constituting the FPC board 50 include polyimide, and examples of a material for the conductor lines 51, 52 (see FIG. 10, described below) include copper. The PTC elements 60 are arranged in close proximity to the bus bars 40, 40a, respectively, on the FPC boards 50.

Each FPC board 50 is bent inward at a right angle and further bent downward at an upper end portion of the end surface member EP1 to be connected to the printed circuit board 21.

(3) Separator

A separator described below is arranged between adjacent battery cells 10 for efficient heat dissipation of the battery cells 10. The separator is formed of resin such as polybutylene terephthalate.

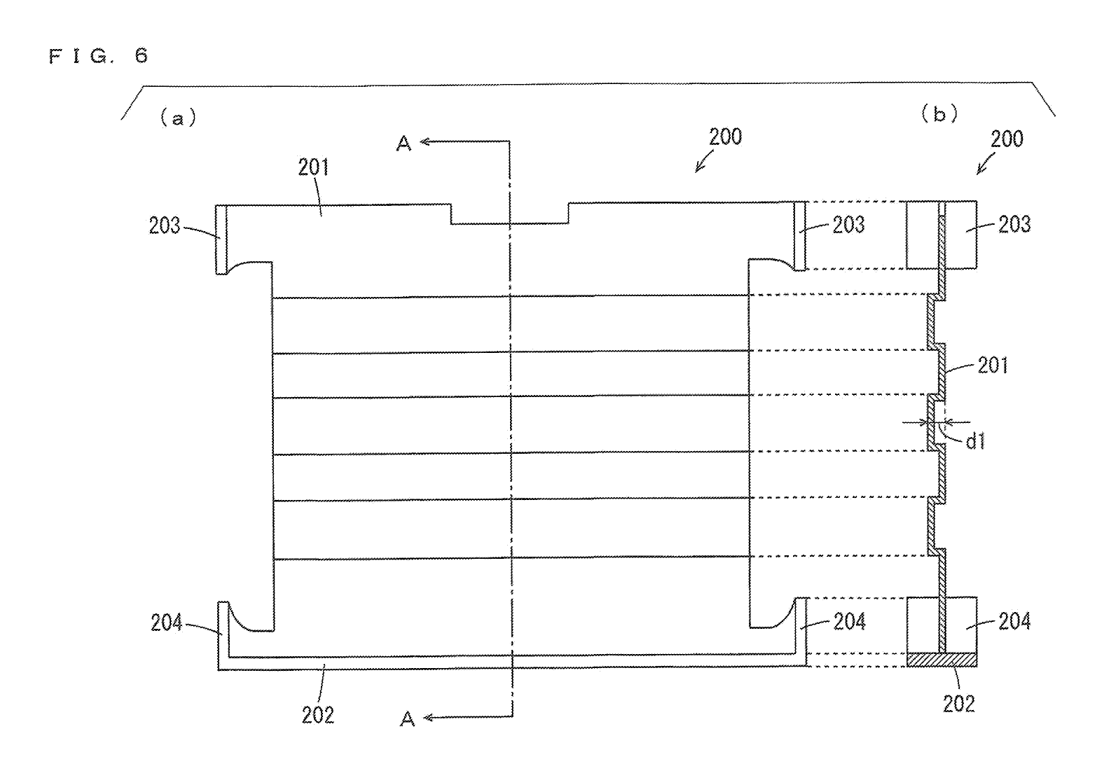

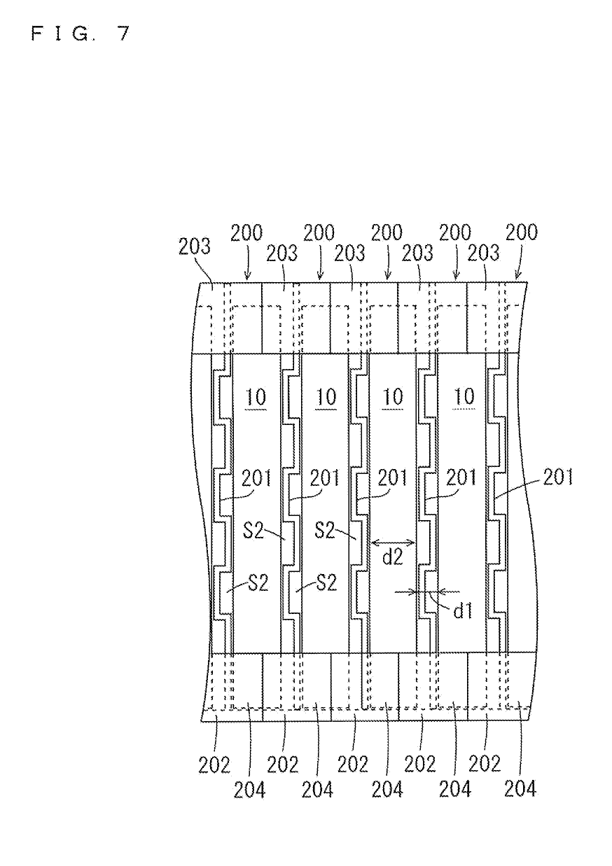

FIG. 6 shows a schematic side view and a schematic sectional view of the separator 200. FIG. 6 (b) shows the cross section taken along the line A-A of FIG. 6 (a). FIG. 7 is a schematic side view showing a plurality of separators 200 each arranged between the plurality of battery cells 10.

As shown in FIG. 6, the separator 200 has a substantially rectangular plate shaped portion 201. The plate shaped portion 201 has a cross section in a top-to-bottom direction that is bent to have irregularities. Hereinafter, the thickness of the plate shaped portion 201 (the depth of irregularities) is referred to as an irregularity width d1.

A long-sized bottom surface portion 202 is provided to horizontally project from the lower end of the plate shaped portion 201 toward the sides of one surface and the other surface of the plate shaped portion 201. A pair of upper side surface portions 203 and a pair of lower side surface portions 204 are provided to project from both side portions of the plate shaped portion 201 toward the sides of the one surface and the other surface of the plate shaped portion 201. The upper side surface portions 203 are provided in the vicinity of the upper end of the plate shaped portion 201. The lower side surface portions 204 are provided in the vicinity of the lower end of the plate shaped portion 201, and coupled to both ends of the bottom surface portion 202.

As shown in FIG. 7, the plurality of separators 200 are arranged to line up in parallel to one another. In this case, the bottom surface portion 202, the upper side surface portion 203 and the lower side surface portion 204 of the separator 200 abut against those of the adjacent separator 200, respectively. In the state, the battery cell 10 is accommodated between the plate shaped portions 201 of the adjacent separators 200.

In the present embodiment, the separators 200 are also arranged between the battery cell 10 arranged at the one end in the X-direction and the end surface member EP1 and between the battery cell 10 arranged at the other end and the end surface member EP2, respectively.

In this case, the one surface and the other surface of each battery cell 10 abut against the plate shaped portions 201 of the adjacent separators 200, respectively. This causes the distance between the adjacent battery cells 10 to be maintained to be equal to the irregularity width d1 of the plate shaped portion 201.

Gaps S2 that correspond to the irregularities of the plate shaped portion 201 are formed between the adjacent battery cells 10. Gas introduced into the battery system 500 of FIG. 1 passes through the gaps S2 between the adjacent battery cells 10, thereby allowing for efficient heat dissipation of the battery cells 10.

(4) Configurations of the Bus Bars and the FPC Boards

Next, description is made of details of the configurations of the bus bars 40, 40a and the FPC boards 50. In the following paragraphs, the bus bar 40 for connecting the plus electrode 10a and the minus electrode 10b of two adjacent battery cells 10 is referred to as the bus bar for two electrodes 40, and the bus bar 40a for connecting the plus electrode 10a or the minus electrode 10b of one battery cell 10 and the power supply line 501 is referred to as the bus bar for one electrode 40a.

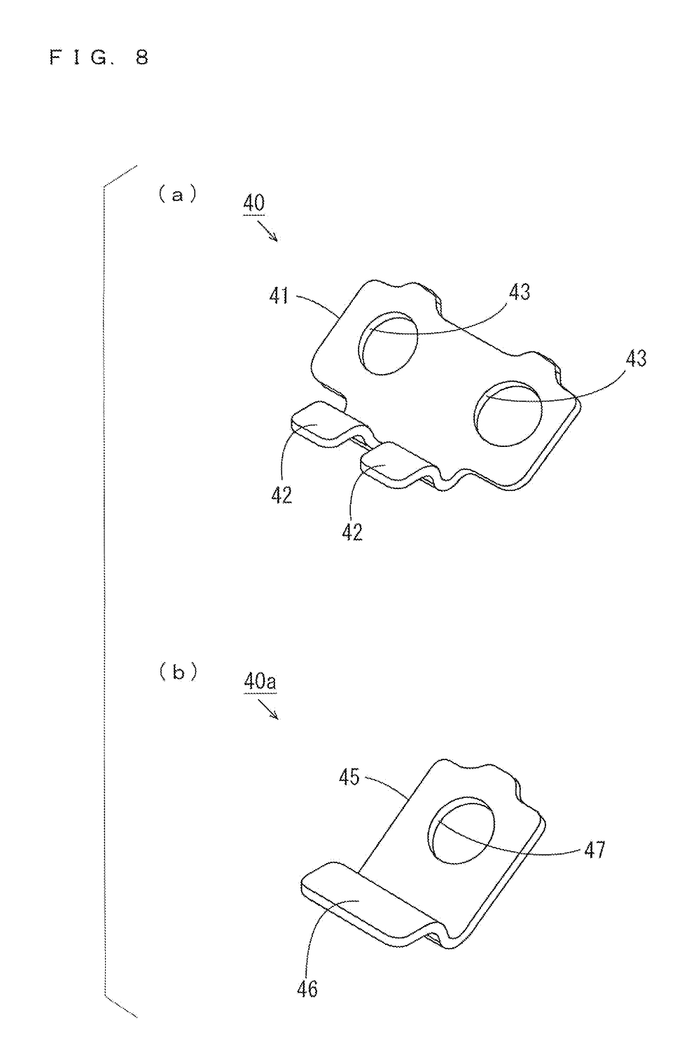

FIG. 8 (a) is an external perspective view of the bus bar for two electrodes 40, and FIG. 8 (b) is an external perspective view of the bus bar for one electrode 40a.

As shown in FIG. 8 (a), the bus bar for two electrodes 40 includes a base portion 41 having a substantially rectangular shape and a pair of attachment portions 42 that is bent and extends from one side of the base portion 41 toward one surface side. A pair of electrode connection holes 43 is formed in the base portion 41.

As shown in FIG. 8 (b), the bus bar for one electrode 40a includes a base portion 45 having a substantially square shape and an attachment portion 46 that is bent and extends from one side of the base portion 45 toward one surface side. An electrode connection hole 47 is formed in the base portion 45.

In the present embodiment, the bus bars 40, 40a are each composed of tough pitch copper having a nickel-plated surface, for example.

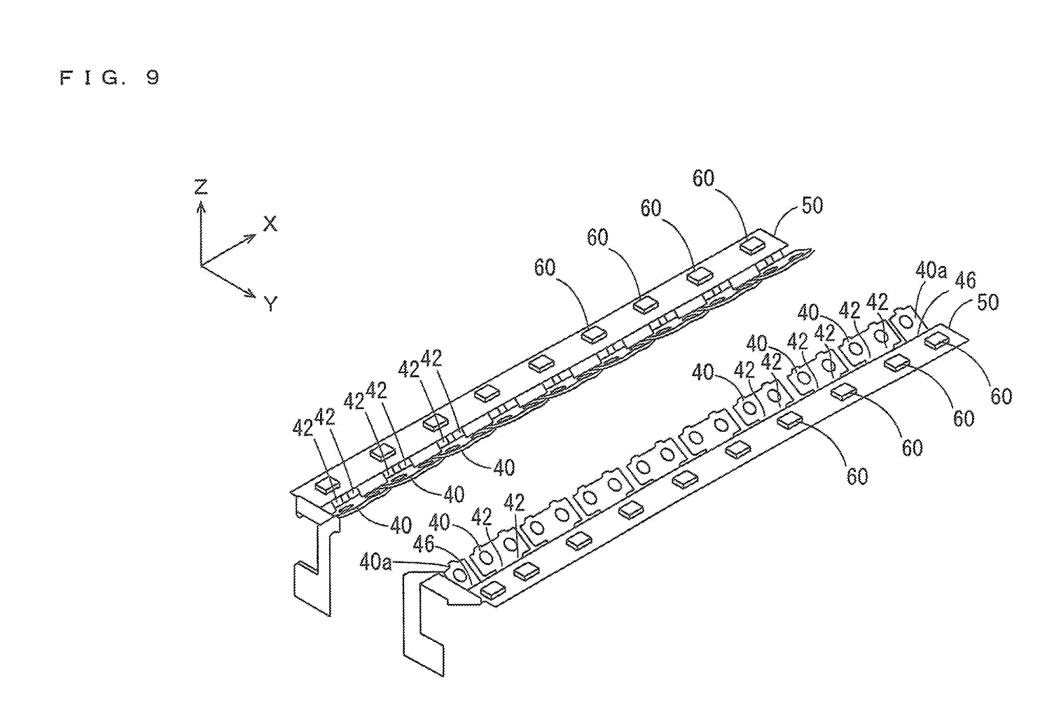

FIG. 9 is an external perspective view of the FPC boards 50 to which the plurality of bus bars 40, 40a and the plurality of PTC elements 60 are attached. As shown in FIG. 9, the attachment portions 42, 46 of the plurality of bus bars 40, 40a are attached to the two FPC boards 50 at given spacings along the X-direction. The plurality of PTC elements 60 are attached to the two FPC boards 50 at the same spacings as the spacings between the plurality of bus bars 40, 40a.

The two FPC boards 50 having the plurality of bus bars 40, 40a and the plurality of PTC elements 60 attached thereto in the foregoing manner are attached to the plurality of battery cells 10 that are integrally fixed by the end surface member EP1 and the battery cell holding member 90 of FIGS. 2 and 3 during the manufacture of the battery module 100.

During the mounting, the plus electrode 10a and the minus electrode 10b of the adjacent battery cells 10 are fitted in the electrode connection holes 43 formed in each bus bar 40. A male thread is formed at each of the plus electrodes 10a and the minus electrodes 10b. With each of the bus bars 40 fitted with the plus electrode 10a and minus electrode 10b of the adjacent battery cells 10, the male threads of the plus electrodes 10a and the minus electrodes 10b are screwed in nuts (not shown).

Similarly, the plus electrode 10a of the eighteenth battery cell 10 and the minus electrode 10b of the first battery cells 10 are fitted in the electrode connection holes 47 formed in the bus bars 40a, respectively. With the bus bars 40a fitted with the plus electrode 10a and minus electrode 10b, respectively, the male threads of the plus electrode 10a and the minus electrode 10b are screwed in nuts (not shown).

In this manner, the plurality of bus bars 40, 40a are attached to the plurality of battery cells 10 while the FPC boards 50 are held in a substantially horizontal attitude by the plurality of bus bars 40, 40a.

(5) Connection Between the Bus Bars and the Detecting Circuit

Description is made of connection between the bus bars 40, 40a and the detecting circuit 20. FIG. 10 is a schematic plan view for explaining connection between the bus bars 40, 40a and the detecting circuit 20. In this example, description is made of connection between the bus bars 40, 40a and the detecting circuit 20 in the battery module 100 to which the detecting circuit 20 is attached.

As shown in FIG. 10, one FPC board 50 is provided with the plurality of conductor lines 51, 52 that correspond to the plurality of bus bars 40, and the other FPC board 50 is provided with the plurality of conductor lines 51, 52 that correspond to the plurality of bus bars 40, 40a. Each conductor line 51 is provided to extend parallel to the Y-direction between the attachment portion 42, 46 of the bus bar 40, 40a and the PTC element 60 arranged in the vicinity of the bus bar 40, 40a. Each conductor line 52 is provided to extend parallel to the X-direction between the PTC element 60 and one end of the FPC board 50.

One end of each conductor line 51 is provided to be exposed on a lower surface of the FPC board 50. The one end of each conductor line 51 exposed on the lower surface is electrically connected to the attachment portion 42, 46 of the bus bar 40, 40a by soldering or welding, for example. Accordingly, the FPC board 50 is fixed to each of the bus bars 40, 40a.

The other end of each conductor line 51 and one end of each conductor line 52 are provided to be exposed on an upper surface of the FPC board 50. A pair of terminals (not shown) of the PTC element 60 is connected to the other end of each conductor line 51 and the one end of each conductor line 52 by soldering, for example.

Each of the PTC elements 60 is preferably arranged in a region between both ends in the X-direction of the corresponding bus bar 40, 40a. When stress is exerted on the FPC board 50, a region of the FPC board 50 between the adjacent bus bars 40, 40a is easily deflected. However, the region of the FPC board 50 between the both ends of each of the bus bars 40, 40a is kept relatively flat because it is fixed to the bus bar 40, 40a. Therefore, each of the PTC elements 60 is arranged within the region of the FPC board 50 between the both ends of each of the bus bars 40, 40a, so that connectivity between the PTC element 60 and the conductor lines 51, 52 is sufficiently ensured. Moreover, the effect of deflection of the FPC board 50 on each of the PTC elements 60 (e.g., a change in the resistance value of the PTC element 60) is suppressed.

A plurality of connection terminals 22 are provided in the printed circuit board 21 corresponding to the plurality of conductor lines 52 of the FPC boards 50, respectively. The other ends of the conductor lines 52 of the FPC boards 50 are connected to the corresponding connection terminals 22 by soldering or welding, for example. Note that the printed circuit board 21 and the FPC boards 50 may not be connected by soldering or welding. For example, connectors may be used for connecting the printed circuit board 21 and the FPC boards 50.

In this manner, each of the bus bars 40, 40a is electrically connected to the detecting circuit 20 via the PTC element 60.

(6) Arrangement of the Battery Modules

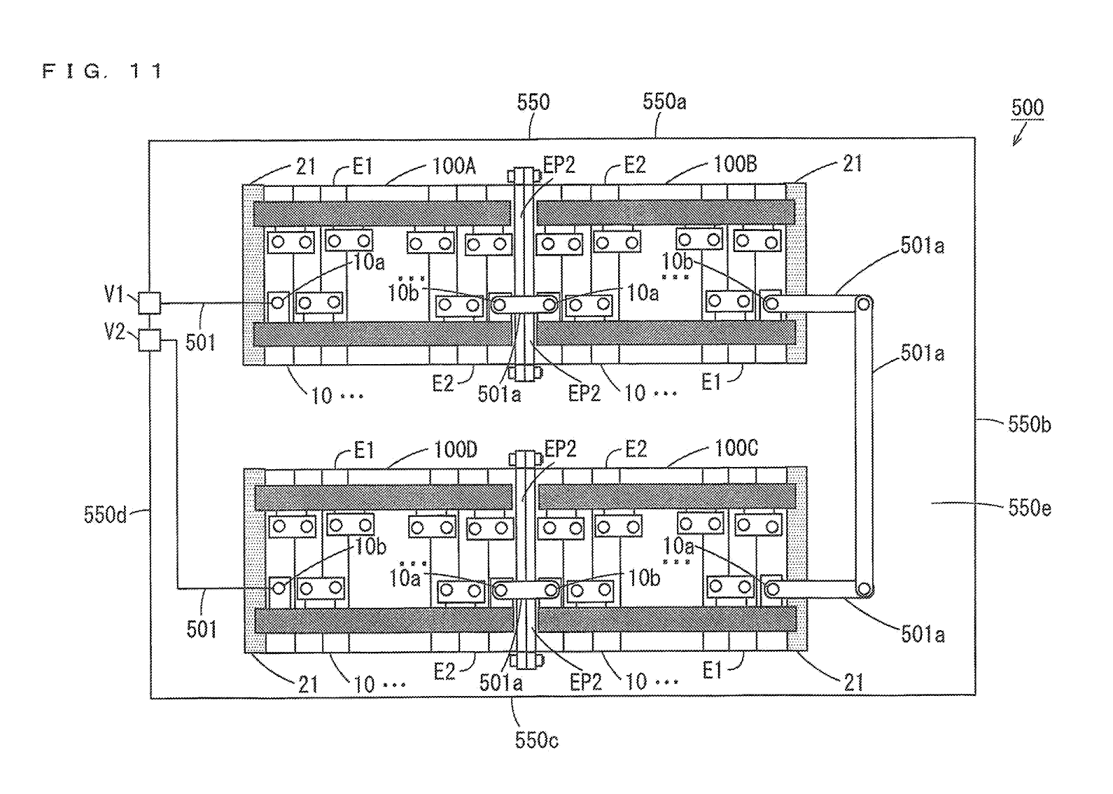

Next, description is made of arrangement of the plurality of battery modules 100 in the battery system 500. FIG. 11 is a schematic plan view showing one example of arrangement of the plurality of battery modules 100 in the battery system 500. FIG. 11 does not show the battery ECU 101 and the contactor 102 (see FIG. 2).

As shown in FIG. 11, the four battery modules 100 are referred to as battery modules 100A, 100B, 100C, 100D for distinction.

A casing 550 has side walls 550a, 550b, 550c, 550d, the bottom surface portion 550e and a cover, which is not shown. The side walls 550a, 550c are parallel to each other, and the side walls 550b, 550d are parallel to each other and perpendicular to the side walls 550a, 550c. The bottom surface portion 550e and the cover are opposite to each other. The side walls 550a to 550d, the bottom surface portion 550e and the cover form an internal space. The four battery modules 100A to 100D are arranged to form two rows and two columns in the internal space within the casing 550.

Within the casing 550, the battery modules 100A, 100B are arranged to form a line such that the end surface member EP2 of the battery module 100A and the end surface member EP2 of the battery module 100B are in contact with each other. In this state, the end surface member EP2 of the battery module 100A and the end surface member EP2 of the battery module 100B are joined to each other. Details will be described below.

Similarly, the battery modules 100C, 100D are arranged to form a line such that the end surface member EP2 of the battery module 100C and the end surface member EP2 of the battery module 100D are in contact with each other. In this state, the end surface member EP2 of the battery module 100C and the end surface member EP2 of the battery module 100D are joined to each other.

Voltage terminals V1, V2 are provided on the side wall 550d. A minus electrode 10b having the lowest potential in the battery module 100A and a plus electrode 10a having the highest potential in the battery module 100B are connected through a bus bar 501a. A minus electrode 10b having the lowest potential in the battery module 100B and a plus electrode 10a having the highest potential in the battery module 100C are connected through a bus bar 501a. A minus electrode 10b having the lowest potential in the battery module 100C and a plus electrode 10a having the highest potential in the battery module 100D are connected through a bus bar 501a.

A plus electrode 10a having the highest potential in the battery module 100A is connected to the voltage terminal V1 through the power supply line 501. A minus electrode 10b having the lowest potential in the battery module 100D is connected to the voltage terminal V2 through the power supply line 501. In this case, the motor or the like of the electric vehicle is connected between the voltage terminals V1, V2, so that electric power generated in the battery modules 100A to 100D connected in series can be supplied to the motor or the like.

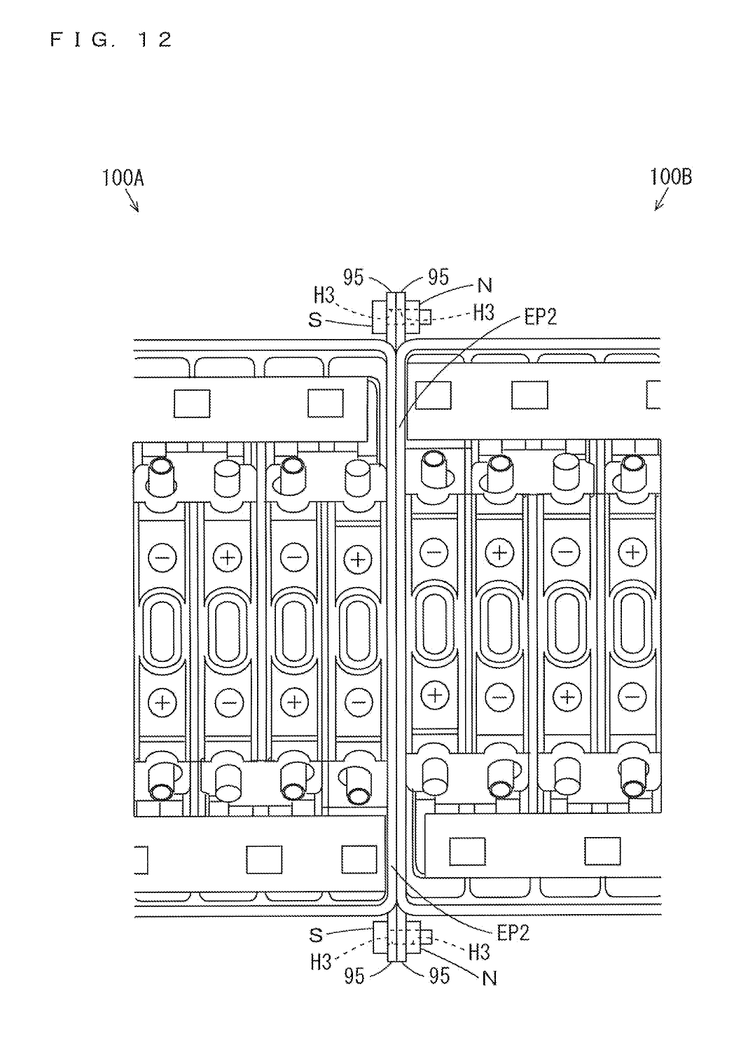

FIG. 12 is an enlarged plan view of a portion where the battery modules 100A, 100B are joined. As shown in FIG. 12, screws S are inserted in the holes H3, H4 of the fastening portions 95, 96 (see FIG. 5), respectively, with the end surface member EP2 of the battery module 100A and the end surface member EP2 of the battery module 100B are in contact with each other, and one fastening portion 95 and the other fastening portion 95 are joined to one fastening portion 95 and the other fastening portion 95, respectively, by the screws S and nuts N, and one fastening portion 96 and the other fastening portion 96 are joined to one fastening portion 96 and the other fastening portion 96, respectively, by the screws S and nuts N. Thus, the end surface member EP2 of the battery module 100A and the end surface member EP2 of the battery module 100B are joined while being in contact with each other. Similarly, the end surface member EP2 of the battery module 100C and the end surface member EP2 of the battery module 100D are joined to each other.

(7) Effects

The battery block 10B of the battery module 100A and the battery block 10B of the battery module 100B are fixed to each other with the end surface member EP2 of the battery module 100A and the end surface member EP2 of the battery module 100B being in contact with each other in the battery system 500 according to the present embodiment. The battery block 10B of the battery module 100C and the battery block 10B of the battery module 100D are fixed to each other with the end surface member EP2 of the battery module 100C and the end surface member EP2 of the battery module 100D being in contact with each other.

In this case, even though the battery cells 10 of the battery modules 100A, 100B expand, stress exerted on the end surface member EP2 of the battery module 100A and stress exerted on the end surface member EP2 of the battery module 100B cancel each other out. Similarly, even though the battery cells 10 of the battery modules 100C, 100D expand, stress exerted on the end surface member EP2 of the battery module 100C and stress exerted on the end surface member EP2 of the battery module 100D cancel each other out. Therefore, the end surface members EP2 are sufficiently prevented from being deformed and damaged even when the thicknesses of the end surface members EP2 are small. This allows for reduced size and weight of the battery system 500.

Moreover, the end surface members EP2 are prevented from being deformed and damaged even when the end surface members EP2 of the battery cell holding members 90 are formed of a low-strength material. This suppresses an increase in manufacturing cost of the battery system 500.

Furthermore, the battery block 10B and the end surface member EP2 are integrally fixed by the fixing members 93, 94 of the battery cell holding member 90. The end surface member EP2 of the battery module 100A and the end surface member EP2 of the battery module 100B are easily and reliably joined to each other by the screws S and the nuts N. Similarly, the end surface member EP2 of the battery module 100C and the end surface member EP2 of the battery module 100D are easily and reliably joined to each other by the screws S and the nuts N.

### [2] Second Embodiment

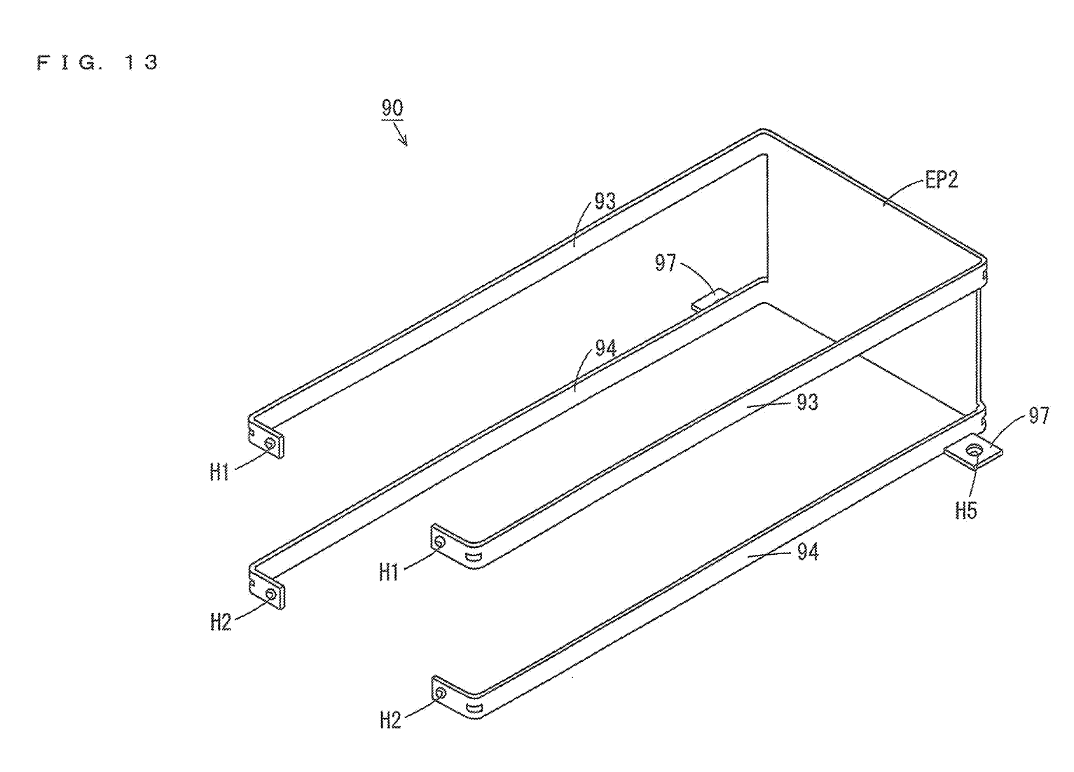

Description will be made of a battery system according to a second embodiment by referring to differences from the battery system 500 according to the first embodiment. In the present embodiment, a battery cell holding member 90 that will be described below is employed instead of the battery cell holding member 90 of FIG. 5. FIG. 13 is an external perspective view of the battery cell holding member 90 in the second embodiment. The battery cell holding member 90 of FIG. 13 is different from the battery cell holding member 90 of FIG. 5 in the following points.

As shown in FIG. 13, a pair of fastening portions 97 are formed to project outward from the lower end of the pair of fixing members 94 in the vicinity of the end surface member EP2 in the battery cell holding member 90. A hole H5 is formed in each fastening portion 97. The fastening portions 95, 96 (see FIG. 5) are not formed in the end surface member EP2.

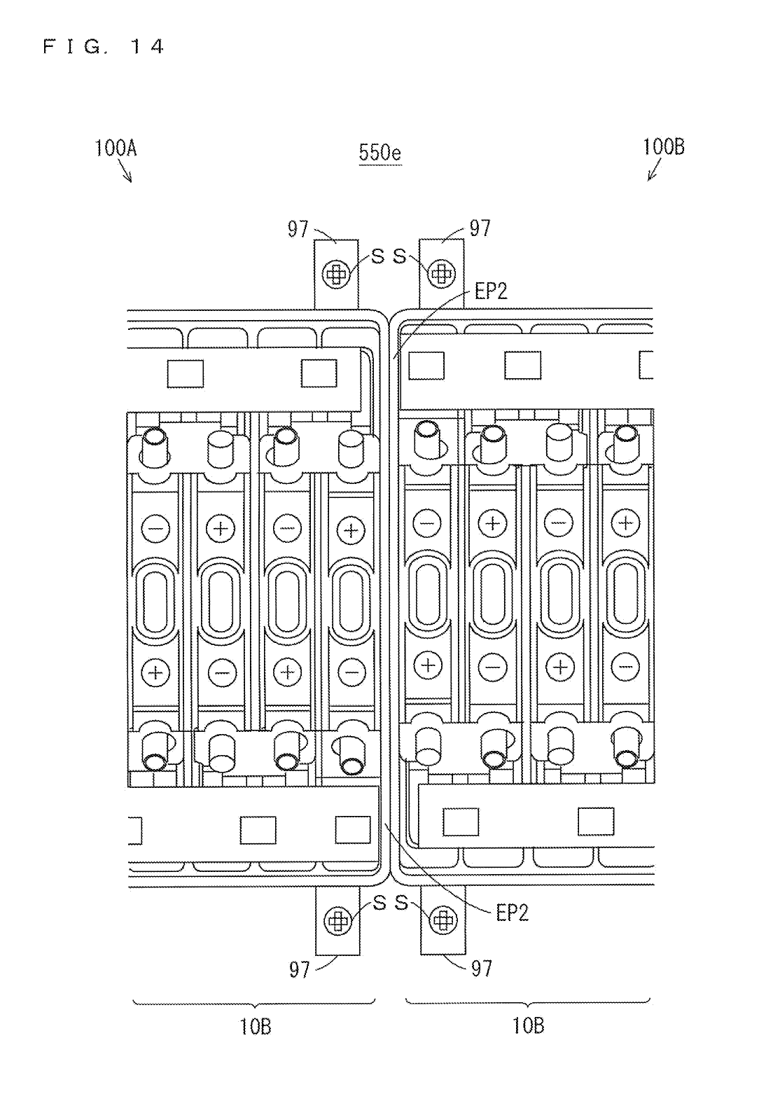

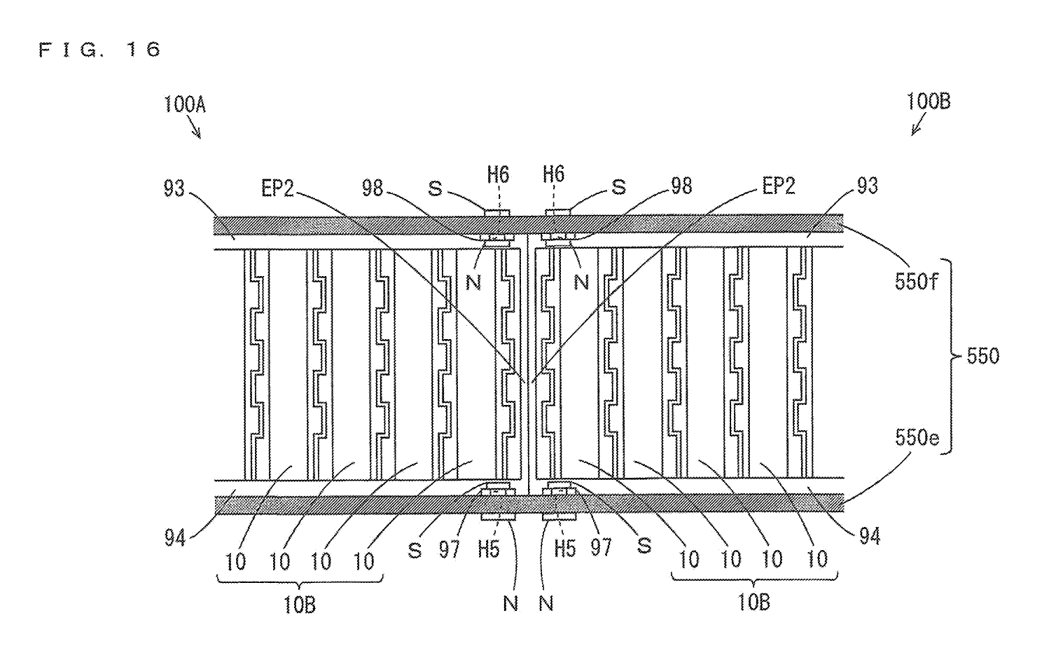

FIG. 14 is an enlarged plan view of a portion where battery modules 100A, 100B are joined in the battery system 500 (see FIG. 11) according to the second embodiment. As shown in FIG. 14, screws S are inserted in the holes H5 of the fastening portions 97 (see FIG. 13), respectively, with the end surface member EP2 of the battery module 100A and the end surface member EP2 of the battery module 100B being in contact with each other, and the fastening portions 97 are fixed to the bottom surface portion 550e of the casing 550 (see FIG. 11) by the screws S and nuts N (see FIG. 16, described below).

As shown in FIG. 2, the fixing member 94 is integrally attached to the battery block 10B. This causes each of the battery blocks 10B of the battery modules 100A, 100B to be fixed to the bottom surface portion 550e of the casing 550 (see FIG. 11).

Similarly, each of the battery blocks 10B of the battery modules 100C, 100D (see FIG. 11) is fixed to the bottom surface portion 550e of the casing 550 with the end surface member EP2 of the battery module 100C and the end surface member EP2 of the battery module 100D being in contact with each other.

Such a configuration eliminates the need for a joining member for joining the end surface member EP2 of the battery module 100A and the end surface member EP2 of the battery module 100B to each other. Similarly, the need for a joining member for joining the end surface member EP2 of the battery module 100C and the end surface member EP2 of the battery module 100D to each other is eliminated. This suppresses higher component cost and an increased number of assembly steps.

### [3] Third Embodiment

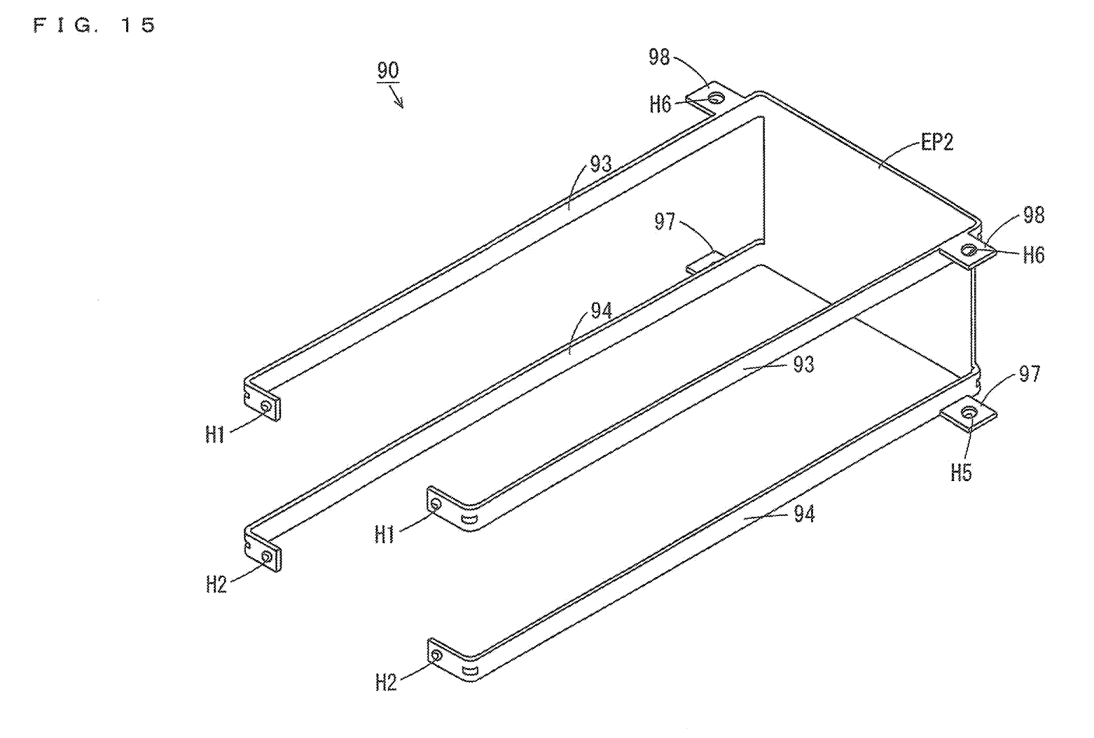

Description will be made of a battery system according to a third embodiment by referring to differences from the battery system 500 according to the second embodiment. In the present embodiment, a battery cell holding member 90 that will be described below is employed instead of the battery cell holding member 90 of FIG. 13. FIG. 15 is an external perspective view of the battery cell holding member 90 in the third embodiment. The battery cell holding member 90 of FIG. 15 is different from the battery cell holding member 90 of FIG. 13 in the following points.

As shown in FIG. 15, a pair of fastening portions 98 are additionally formed to project outward from the upper end of the pair of fixing members 93 in the vicinity of the end surface member EP2 in the battery cell holding member 90. A hole H6 is formed in each fastening portion 98.

FIG. 16 is an enlarged side view of a portion where battery modules 100A, 100B are joined in the battery system 500 (see FIG. 11) according to the third embodiment. The casing 550 that accommodates the battery modules 100A, 100B is indicated by hatching in FIG. 16. In the present embodiment, through holes are formed in advance in given positions of the cover 550f that constitutes the casing 550.

As shown in FIG. 16, screws S are inserted in the holes H6 of the fastening portions 98 through the through holes of the cover 550f with the end surface member EP2 of the battery module 100A and the end surface member EP2 of the battery module 100B being in contact with each other, and the fastening portions 98 are fixed to the cover 550f of the casing 550 by the screws S and nuts N.

Accordingly, the end surface members EP2 are fixed to the bottom surface portion 550e and the cover 550f of the casing 550 by the screws S and the nuts N with the end surface member EP2 of the battery module 100A and the end surface member EP2 of the battery module 100B being in contact with each other. As a result, each of the battery blocks 10B of the battery modules 100A, 100B is easily and reliably fixed to the casing 550.

Similarly, the end surface members EP2 are fixed to the bottom surface portion 550e and the cover 550f of the casing 550 by screws S and nuts N with the end surface member EP2 of the battery module 100C (see FIG. 11) and the end surface member EP2 of the battery module 100D (see FIG. 11) being in contact with each other. As a result, each of the battery blocks 10B of the battery modules 100C, 100D is easily and reliably fixed to the casing 550.

### [4] Fourth Embodiment

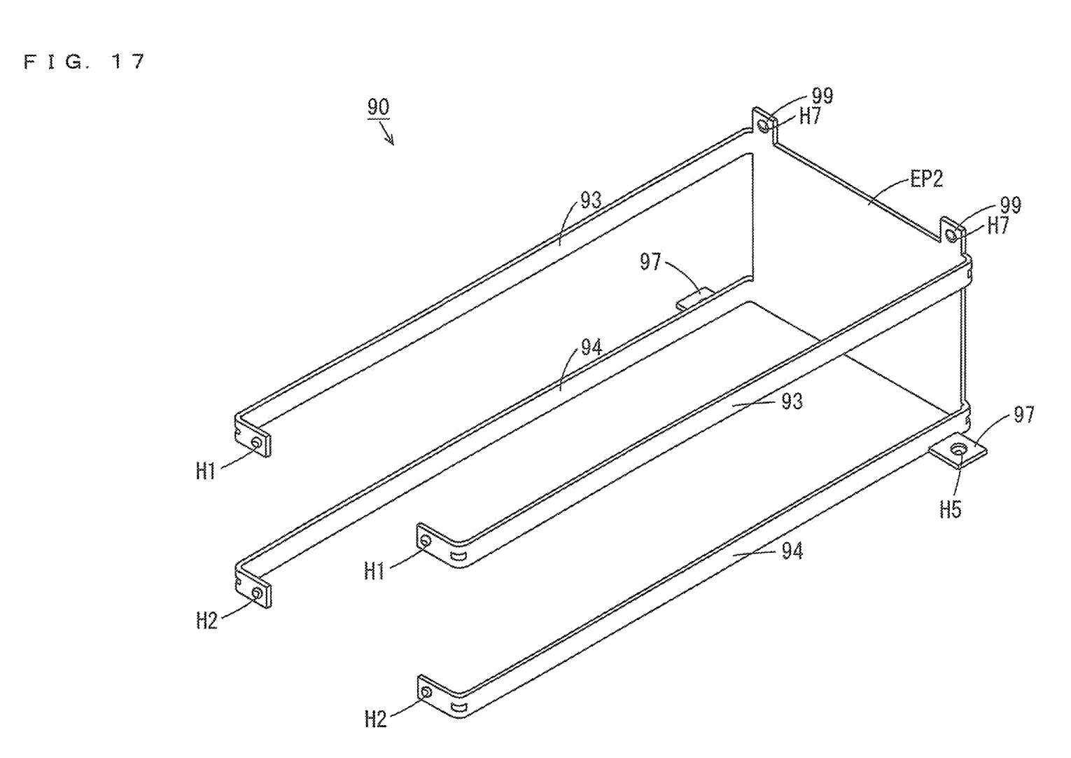

Description will be made of a battery system according to a fourth embodiment by referring to differences from the battery system 500 according to the second embodiment. In the present embodiment, a battery cell holding member 90 that will be described below is employed instead of the battery cell holding member 90 of FIG. 13. FIG. 17 is an external perspective view of the battery cell holding member 90 in the fourth embodiment. The battery cell holding member 90 of FIG. 17 is different from the battery cell holding member 90 of FIG. 13 in the following points.

As shown in FIG. 17, a pair of fastening portions 99 is additionally formed to project upward from the vicinity of the both ends on the upper side of the end surface member EP2 in the battery cell holding member 90. A hole H7 is formed in each fastening portion 99.

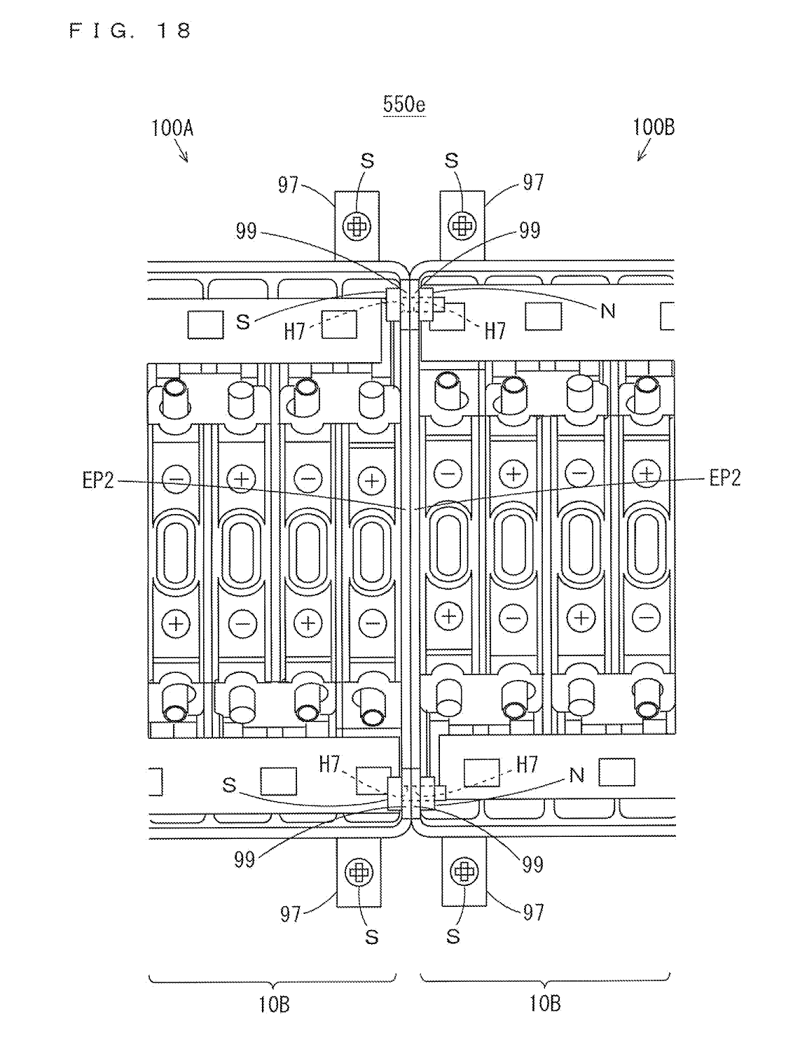

FIG. 18 is an enlarged plan view of a portion where battery modules 100A, 100 B are joined in the battery system 500 (see FIG. 11) according to the fourth embodiment. As shown in FIG. 18, in upper portions of the battery modules 100A, 100B, the pair of fastening portions 99 of the battery module 100A and the pair of fastening portions 99 of the battery module 100B are aligned to overlap, respectively, with the end surface member EP2 of the battery module 100A and the end surface member EP2 of the battery module 100B being in contact with each other.

In this state, screws S are inserted in the holes H7 of the two fastening portions 99 that are aligned with each other, and the one fastening portion 99 is joined to the other fastening portion 99 by the screws S and the nuts N. Similarly to the second embodiment, the pair of fastening portions 97 is fixed to the bottom surface portion 550e in lower portions of the battery modules 100A, 100B.

Thus, the end surface member EP2 of the battery module 100A and the end surface member EP2 of the battery module 100B are fixed to the bottom surface portion 550e of the casing 550 (see FIG. 11) while being in contact with each other. As a result, the end surface members EP2 can be more reliably prevented from being deformed and damaged.

Similarly, the end surface member EP2 of the battery module 100C (see FIG. 11) and the end surface member EP2 of the battery module 100D (see FIG. 11) are fixed to the bottom surface portion 550e of the casing 550 while being in contact with each other. As a result, the end surface members EP2 can be more reliably prevented from being deformed and damaged.

While the pair of fastening portions 99 is formed on the upper side of the end surface member EP2 in the present embodiment, the pair of fastening portions 99 may be formed on both lateral sides of the end surface member EP2, respectively, for example.

### [5] Fifth Embodiment

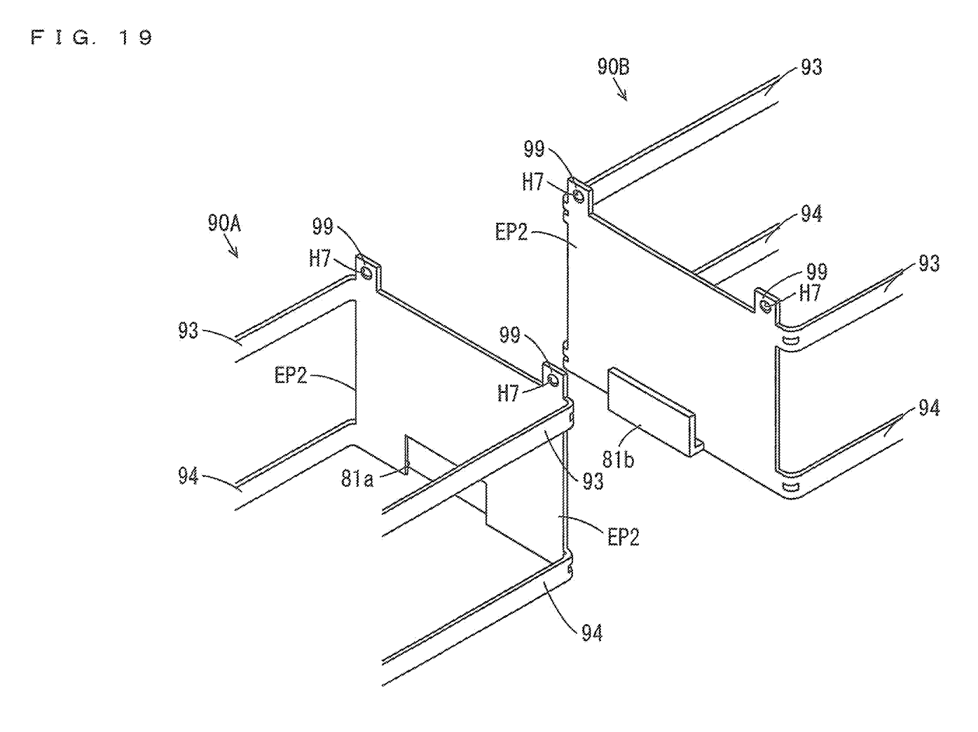

Description will be made of a battery system according to a fifth embodiment by referring to differences from the battery system 500 according to the first embodiment. In the present embodiment, battery cell holding members 90A, 90B that will be described below are employed instead of two battery cell holding members 90 of FIG. 5. FIG. 19 is an external perspective view of the battery cell holding members 90A, 90B in the fifth embodiment. The battery cell holding members 90A, 90B of FIG. 19 are different from the battery cell holding member 90 of FIG. 5 in the following points.

As shown in FIG. 19, a rectangular concave portion 81a is formed on an inner surface at the center of the lower side of the end surface member EP2 in the battery cell holding member 90A. In the battery cell holding member 90A, the pair of fastening portions 99 is formed to project upward from the vicinity of the both ends on the upper side of the end surface member EP2 instead of the fastening portions 95, 96 formed on the both lateral sides of the end surface member EP2 of FIG. 5. The hole H7 is formed in each fastening portion 99.

Meanwhile, a latch portion 81b having an L-shaped cross section (a hook-shaped cross section) is formed to project outward and to be bent upward from the center of the lower side of the end surface member EP2 in the battery cell holding member 90B. The latch portion 81b is formed such that it can be fitted in the concave portion 81a of the battery cell holding member 90A. Also in the battery cell holding member 90B, the pair of fastening portions 99 is formed to project upward from the vicinity of the both ends on the upper side of the end surface member EP2 instead of the fastening portions 95, 96 formed on the both lateral sides of the end surface member EP2 of FIG. 5. The hole H7 is formed in each fastening portion 99.

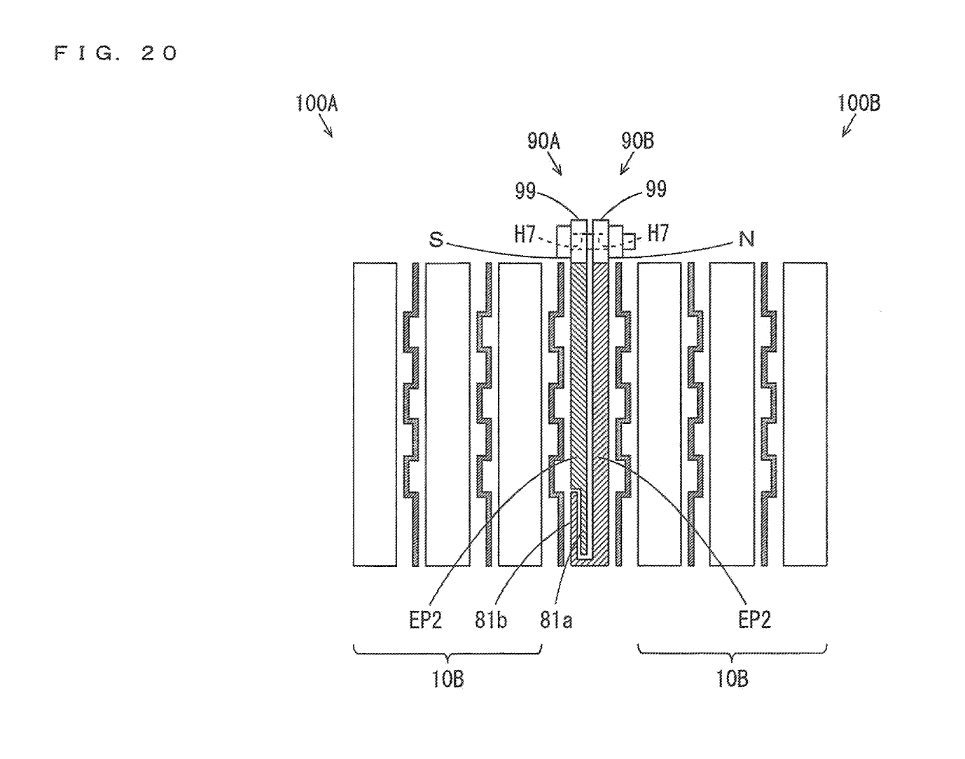

FIG. 20 is a vertical sectional view of a portion where battery modules 100A, 100B are joined in the battery system 500 (see FIG. 11) according to the fifth embodiment. In the present embodiment, the battery blocks 10B of the battery modules 100A, 100D (see FIG. 11) are fixed by respective battery cell holding members 90A. The battery blocks 10B of the battery modules 100B, 100C (see FIG. 11) are fixed by respective battery cell holding members 90B.

The latch portion 81b of the battery module 100B is fitted in the concave portion 81a of the battery module 100A. Accordingly, the pair of fastening portions 99 of the battery module 100A and the pair of fastening portions 99 of the battery module 100B are aligned to overlap, respectively, with the end surface member EP2 of the battery module 100A and the end surface member EP2 of the battery module 100B being in contact with each other.

In this state, the screw S is inserted in the holes H7 of the two fastening portions 99 that are aligned with each other, and the one fastening portion 99 is joined to the other fastening portion 99 by the screw S and the nut N. Thus, the end surface member EP2 of the battery module 100A and the end surface member EP2 of the battery module 100B are joined while being in contact with each other.

Similarly, the end surface member EP2 of the battery module 100C and the end surface member EP2 of the battery module 100D are joined while being in contact with each other.

Such a configuration eliminates the need to join the lower end of the end surface member EP2 of the battery cell holding member 90A and the lower end of the end surface member EP2 of the battery cell holding member 90B by the screws. This suppresses an increased number of assembly steps. The plurality of fastening portions 99 are aligned by only fitting the latch portion 81b of the battery cell holding member 90B in the concave portion 81a of the battery cell holding member 90A, thus facilitating the assembly of the battery modules 100A to 100D.

### [6] Sixth Embodiment

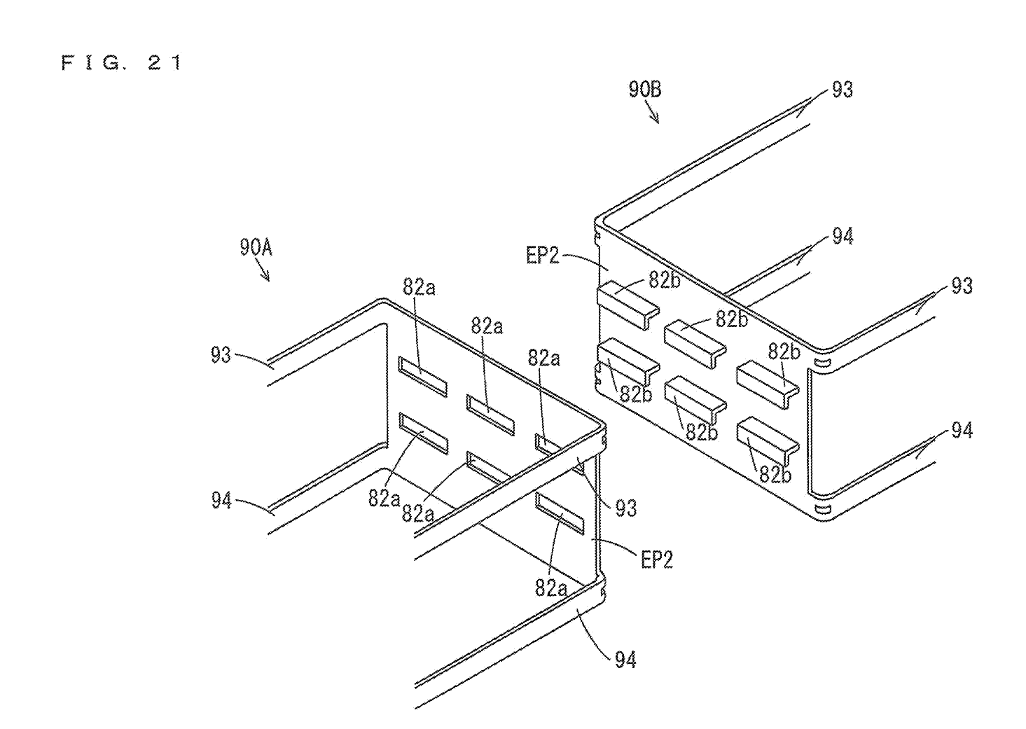

Description will be made of a battery system according to a sixth embodiment by referring to differences from the battery system 500 according to the fifth embodiment. In the present embodiment, battery cell holding members 90A, 90B that will be described below are employed instead of the battery cell holding members 90A, 90B of FIG. 19. FIG. 21 is an external perspective view of the battery cell holding members 90A, 90B in the sixth embodiment. The battery cell holding members 90A, 90B of FIG. 21 are different from the battery cell holding members 90A, 90B of FIG. 19 in the following points.

As shown in FIG. 21, the concave portion 81a and the fastening portions 99 of FIG. 19 are not formed in the end surface member EP2, and six insertion holes 82a are formed to line up in two rows and three columns at substantially the center of the end surface member EP2 in the battery cell holding member 90A.

Meanwhile, in the battery cell holding member 90B, the latch portion 81b and the fastening portions 99 of FIG. 19 are not formed in the end surface member EP2, and a plurality of latch portions 82b each having an inverted L-shaped cross section (a hook-shaped cross section) are formed to project outward from the end surface member EP2 and to be bent downward. In the example of FIG. 21, the six latch portions 82b are formed to line up in two rows and three columns on an outer surface at substantially the center of the end surface member EP2 to correspond to the six insertion holes 82a of the battery cell holding member 90A, respectively. The plurality of latch portions 82b are formed such that they can be fitted in the plurality of insertion holes 82a, respectively, of the battery cell holding member 90A.

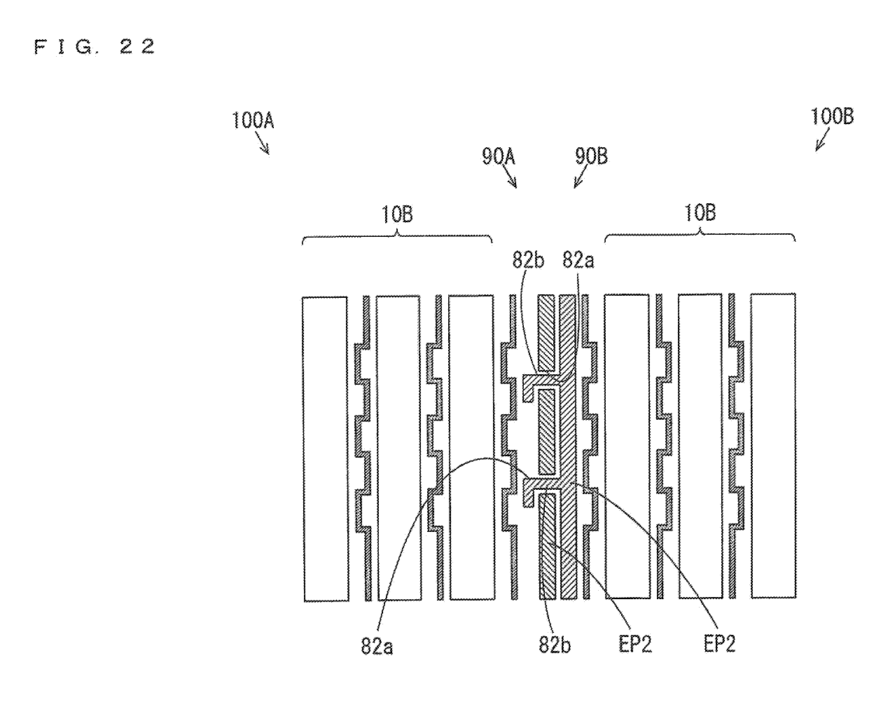

FIG. 22 is a vertical sectional view of a portion where battery modules 100A, 100B are joined in the battery system 500 (see FIG. 11) according to the sixth embodiment. In the present embodiment, the battery blocks 10B of the battery modules 100A, 100D (see FIG. 11) are fixed by respective battery cell holding members 90A. The battery blocks 10B of the battery modules 100B, 100C (see FIG. 11) are fixed by respective battery cell holding members 90B.

As shown in FIG. 22, the plurality of latch portions 82b of the battery module 100B are fitted in the plurality of insertion holes 82a of the battery module 100A. Thus, edges of the insertion holes 82a of the battery module 100A are latched by the latch portions 82b of the battery module 100B, and the end surface member EP2 of the battery module 100A and the end surface member EP2 of the battery module 100B are joined while being in contact with each other. Similarly, the end surface member EP2 of the battery module 100C and the end surface member EP2 of the battery module 100D are joined to each other.

Such a configuration causes the end surface member EP2 of the battery cell holding member 90A and the end surface member EP2 of the battery cell holding member 90B to be joined by only fitting the latch portions 82b of the battery cell holding member 90B in the insertion holes 82a of the battery cell holding member 90A. This suppresses an increased number of assembly steps.

### [7] Seventh Embodiment

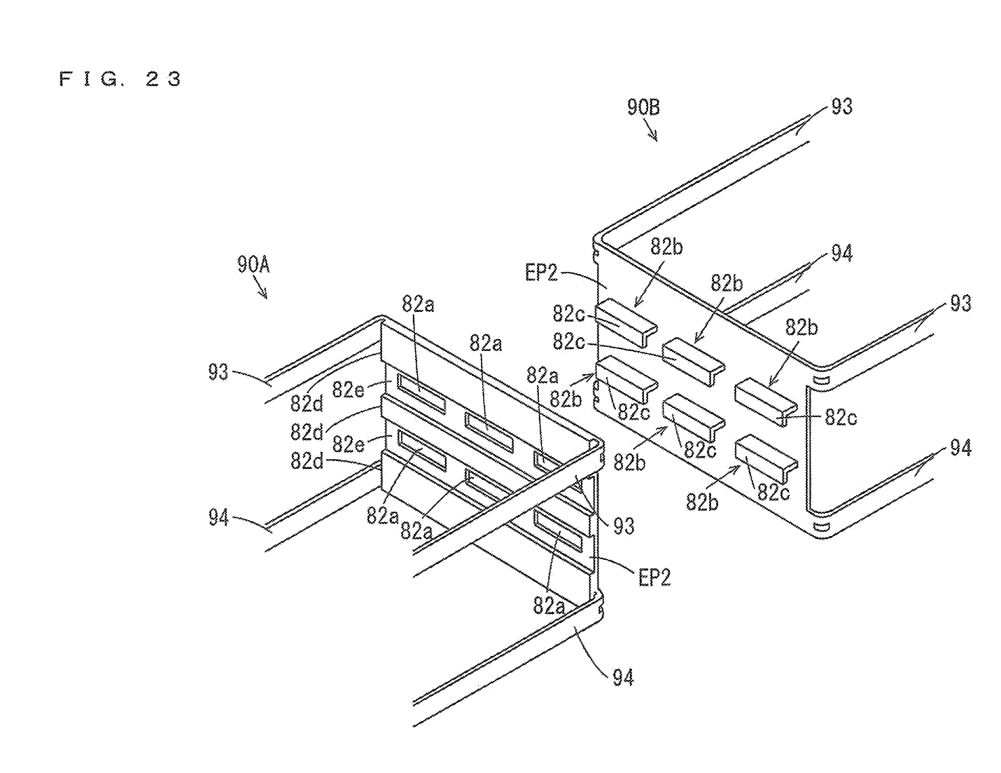

Description will be made of a battery system according to a seventh embodiment by referring to differences from the battery system 500 according to the sixth embodiment. In the present embodiment, battery cell holding members 90A, 90B that will be described below are employed instead of the battery cell holding members 90A, 90B of FIG. 21. FIG. 23 is an external perspective view of the battery cell holding members 90A, 90B in the seventh embodiment. The battery cell holding members 90A, 90B of FIG. 23 are different from the battery cell holding members 90A, 90B of FIG. 21 in the following points.

As shown in FIG. 23, similarly to the battery cell holding member 90B of FIG. 21, the plurality of latch portions 82b each having the inverted L-shaped cross section (the hook-shaped cross section) are formed to project outward from the end surface member EP2 and to be bent downward in the battery cell holding member 90B. A bent portion at the tip of each latch portion 82b is referred to as a bent portion 82c in the following description.

Meanwhile, similarly to the battery cell holding member 90A of FIG. 21, the six insertion holes 82a are formed to line up in two rows and three columns at substantially the center of the end surface member EP2 in the battery cell holding member 90A. Here, the end surface member EP2 includes thick portions 82d and thin portions 82e. The plurality of insertion holes 82a are formed in the thin portions 82e.

In the present embodiment, a difference between the thickness of each of the thick portions 82d and the thickness of each of the thin portions 82e is determined to be substantially equal to the thickness of each of the bent portions 82c of the latch portions 82b. The thickness of the thin portion 82e is determined to be substantially equal to the distance between the bent portions 82c of the battery cell holding member 90B and the outer surface of the end surface member EP2.

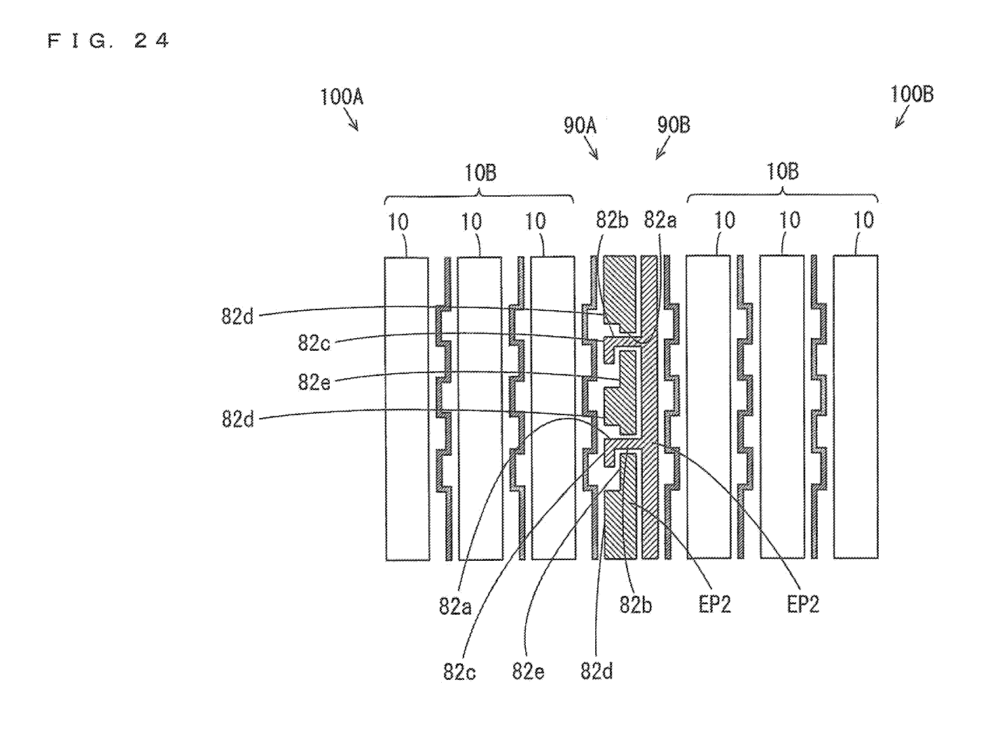

FIG. 24 is a vertical sectional view of a portion where battery modules 100A, 100B are joined in the battery system 500 (see FIG. 11) according to the seventh embodiment. In the present embodiment, the battery blocks 10B of the battery modules 100A, 100D (see FIG. 11) are fixed by respective battery cell holding members 90A. The battery blocks 10B of the battery modules 100B, 100C (see FIG. 11) are fixed by respective battery cell holding members 90B.

As shown in FIG. 24, the plurality of latch portions 82b of the battery module 100B are fitted in the plurality of insertion holes 82a of the battery module 100A. Thus, the edges of the insertion holes 82a of the battery module 100A are latched by the latch portions 82b of the battery module 100B, and the end surface member EP2 of the battery module 100A and the end surface member EP2 of the battery module 100B are joined while being in contact with each other. In this case, the thicknesses of the thick portions 82d and the thin portions 82e are determined in the foregoing manner, so that outer surfaces of the bent portions 82c of the latch portions 82b of the battery module 100B are substantially flush with inner surfaces of the thick portions 82d of the battery module 100A.

Similarly, the end surface member EP2 of the battery module 100C and the end surface member EP2 of the battery module 100D are joined to each other. Outer surfaces of the bent portions 82c of the latch portions 82b of the battery module 100C are substantially flush with inner surfaces of the thick portions 82d of the battery module 100D.

Such a configuration prevents the bent portions 82c of the battery cell holding member 90B from projecting to the inside of the inner surface of the battery cell holding member 90A. Accordingly, the end surface of the battery block 10B of the battery module 100A is fixed by the thick portions 82d and the thin portions 82e of the end surface member EP2 of the battery cell holding member 90A and the latch portions 82b of the battery cell holding member 90B.

This does not cause stress due to expansion of the battery cells 10 of the battery modules 100A, 100B to be focused and applied on the bent portions 82c of the latch portions 82b of the battery module 100B. This more reliably prevents the end surface members EP2 from being deformed and damaged.

Similarly, stress due to expansion of the battery cells 10 of the battery modules 100C, 100D is not focused and applied on the bent portions 82c of the latch portions 82b of the battery module 100C. This more reliably prevents the end surface members EP2 from being deformed and damaged.

### [8] Eighth Embodiment

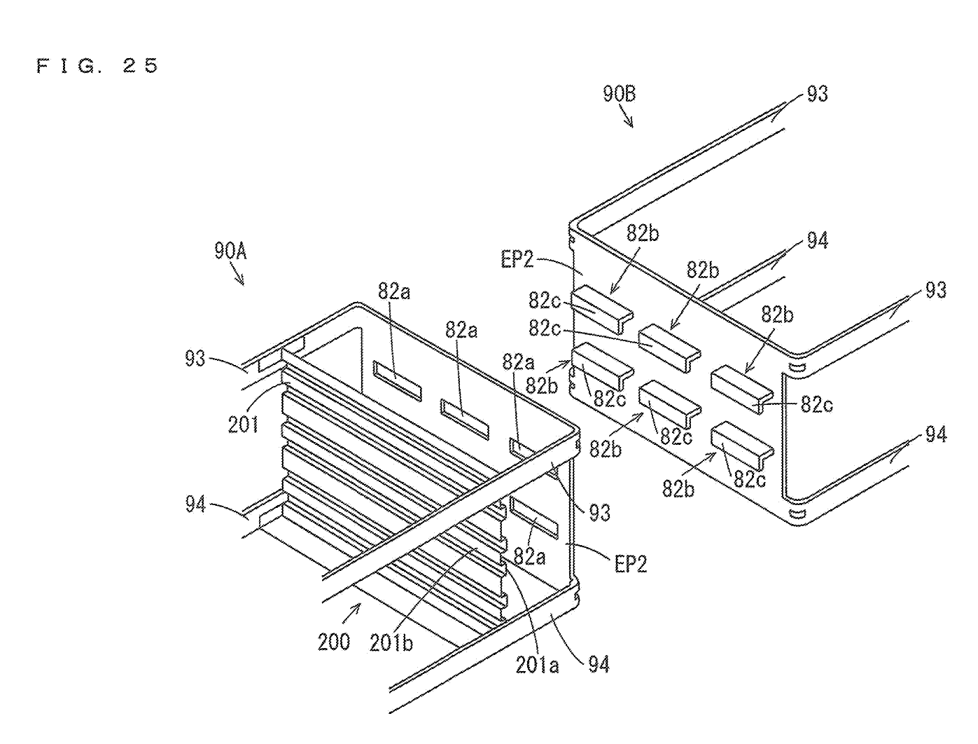

Description will be made of a battery system according to an eighth embodiment by referring to differences from the battery system 500 according to the sixth embodiment. In the present embodiment, battery cell holding members 90A, 90B that will be described below are employed instead of the battery cell holding members 90A, 90B of FIG. 21. FIG. 25 is an external perspective view of the battery cell holding members 90A, 90B in the eighth embodiment. The battery cell holding members 90A, 90B of FIG. 25 are different from the battery cell holding members 90A, 90B of FIG. 21 in the following points.

As shown in FIG. 25, similarly to the battery cell holding member 90B of FIG. 21, the plurality of latch portions 82b each having the inverted L-shaped cross section (the hook-shaped cross section) are formed to project outward from the end surface member EP2 and to be bent downward in the battery cell holding member 90B. The bent portion at the tip of the latch portion 82b is referred to as the bent portion 82c in the following description. The length in a top-to-bottom direction of the bent portion 82c is referred to as a bending length.

Meanwhile, similarly to the battery cell holding member 90A of FIG. 21, the six insertion holes 82a are formed to line up in two rows and three columns at substantially the center of the end surface member EP2 in the battery cell holding member 90A.

In the present embodiment, the separator 200 is attached to come in contact with the inner surface of the end surface member EP2 of the battery cell holding member 90A. As described above, the plate shaped portion 201 of the separator 200 has the cross section in the top-to-bottom direction that is bent to have irregularities. Thus, when attached to the battery cell holding member 90A, the plate shaped portion 201 has parts of its one surface coming in contact with the end surface member EP2 and parts of its other surface not coming in contact with the end surface member EP2. In the following paragraphs, the parts of the one surface of the plate shaped portion 201 coming in contact with the end surface member EP2 are referred to as one surface portions 201a, and the parts of the other surface of the plate shaped portion 201 not coming in contact with the end surface member EP2 are referred to as other surface portions 201b.

The other surface portions 201b of the separator 200 attached to the battery cell holding member 90A are formed to be opposite to the latch portions 82b of the battery cell holding member 90B in the present embodiment. The length in the top-to-bottom direction of each of the other surface portions 201b being opposite to the latch portions 82b is determined to be larger than the bending length of the bent portions 82c of the battery cell holding member 90B.

The irregularity width d1 (see FIG. 6) of the separator 200 attached to the battery cell holding member 90A is determined to be larger than a value obtained by adding the thickness of each of the bent portions 82c of the battery cell holding member 90B and the thickness of the plate shaped portion 201.

The thickness of the end surface member EP2 of the battery cell holding member 90A is determined to be substantially equal to the distance between the bent portions 82c of the battery cell holding member 90B and the outer surface of the end surface member EP2.

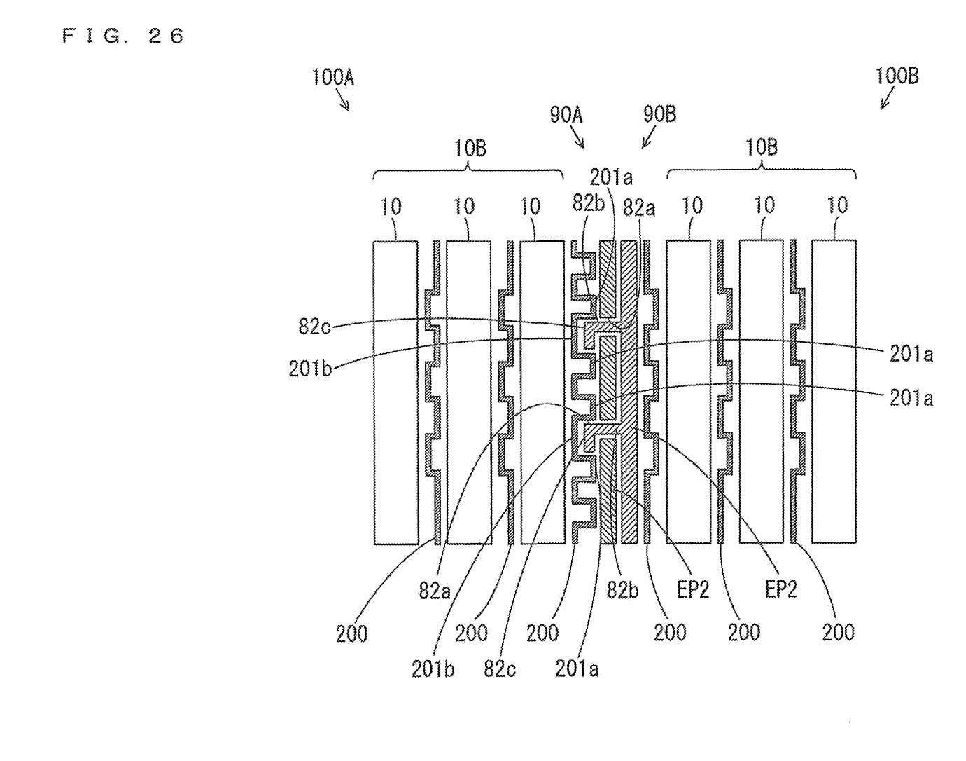

FIG. 26 is a vertical sectional view of a portion where battery modules 100A, 100B are joined in the battery system 500 (see FIG. 11) according to the eighth embodiment. In the present embodiment, the battery blocks 10B of the battery modules 100A, 100D (see FIG. 11) are fixed by respective battery cell holding members 90A via respective separators 200 of FIG. 25. The battery blocks 10B of the battery modules 100B, 100C (see FIG. 11) are fixed by respective battery cell holding members 90B.

As shown in FIG. 26, the plurality of latch portions 82b of the battery module 100B are fitted in the plurality of insertion holes 82a of the battery module 100A. Thus, the edges of the insertion holes 82a of the battery module 100A are latched by the latch portions 82b of the battery module 100B, and the end surface member EP2 of the battery module 100A and the end surface member EP2 of the battery module 100B are joined while being in contact with each other.

In this case, as described above, the shape of the plate shaped portion 201 of the separator 200 attached to the battery cell holding member 90A is determined, so that the bent portions 82c of the battery cell holding member 90B that project to the inside of the inner surface of the battery cell holding member 90A are accommodated in spaces formed between the other surface portions 201b that are opposite to the latch portions 82b and the inner surface of the battery cell holding member 90A.

Such a configuration causes the end surface of the battery block 10B of the battery module 100A to be fixed by the other surface portions 201b of the separator 200 attached to the battery cell holding member 90A. This does not cause stress due to expansion of the battery cells 10 of the battery modules 100A, 100B to be focused and applied on the bent portions 82c of the latch portions 82b of the battery module 100B. This more reliably prevents the end surface members EP2 from being deformed and damaged.

Similarly, stress due to expansion of the battery cells 10 of the battery modules 100C, 100D is not focused and applied on the bent portions 82c of the latch portions 82b of the battery module 100C. This more reliably prevents the end surface members EP2 from being deformed and damaged.

### [9] Ninth Embodiment

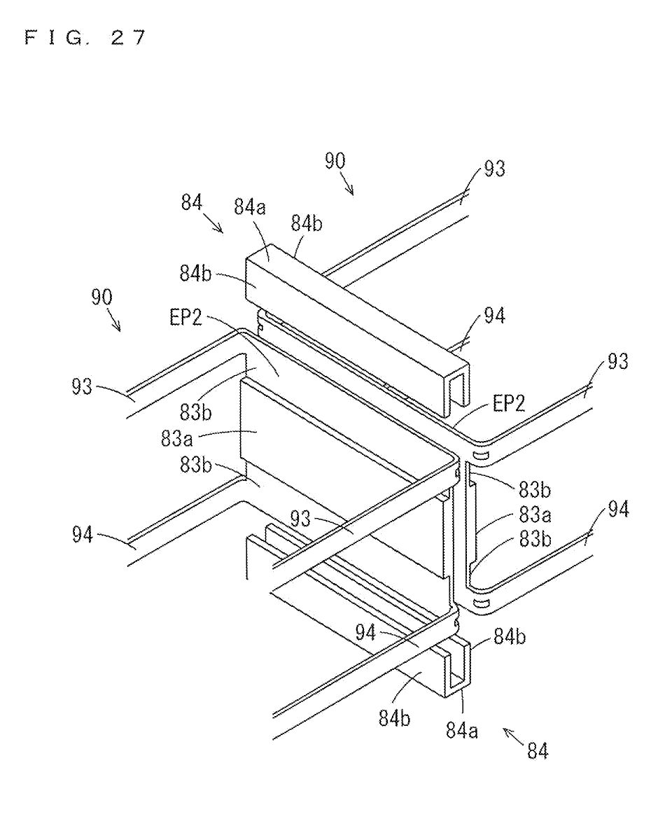

Description will be made of a battery system according to a ninth embodiment by referring to differences from the battery system 500 according to the first embodiment. In the present embodiment, battery cell holding members 90 that will be described below are employed instead of two battery cell holding members 90 of FIG. 5. FIG. 27 is an external perspective view of the battery cell holding members 90 in the ninth embodiment. The battery cell holding members 90 of FIG. 27 are different from the battery cell holding member 90 of FIG. 5 in the following points.

As shown in FIG. 27, each of the end surface member EP2 includes the thick portion 83a and the thin portions 83b in the battery cell holding member 90. The thick portion 83a is positioned at substantially the center of the end surface member EP2 in the top-to-bottom direction. The thin portions 83b are positioned close to the upper side and the lower side, respectively, of the end surface member EP2 to sandwich the thick portion 83a therebetween. The outer surface of the end surface member EP2 is flat. Thus, the thick portion 83a projects inward from the outer surface of the end surface member EP2.

The end surface members EP2 of the two battery cell holding members 90 are joined while being in contact with each other in the battery system 500 (see FIG. 11) in the present embodiment. Two sandwiching members 84 are used for joining the two end surface members EP2. Each sandwiching member 84 has a bottom surface portion 84a and two side surface portions 84b, and formed such that its U-shape cross section extends a given length.

One sandwiching member 84 is attached to cover the upper sides of the two end surface members EP2 that are aligned to overlap each other. This causes the upper sides and portions in proximity thereto of the two end surface members EP2 to be sandwiched between the two side surface portions 84b of the sandwiching member 84. The other sandwiching member 84 is attached to cover the lower sides of the two end surface members EP2 that are aligned to overlap each other. This causes the lower sides and portions in proximity thereto of the two end surface members EP2 to be sandwiched between the two side surface portions 84b of the sandwiching member 84.

The gap between the thickness of the thick portion 83a and the thickness of each of the thin portions 83b of the battery cell holding member 90 is determined to be substantially equal to the thickness of the side surface portion 84b of the sandwiching member 84 in the present embodiment.

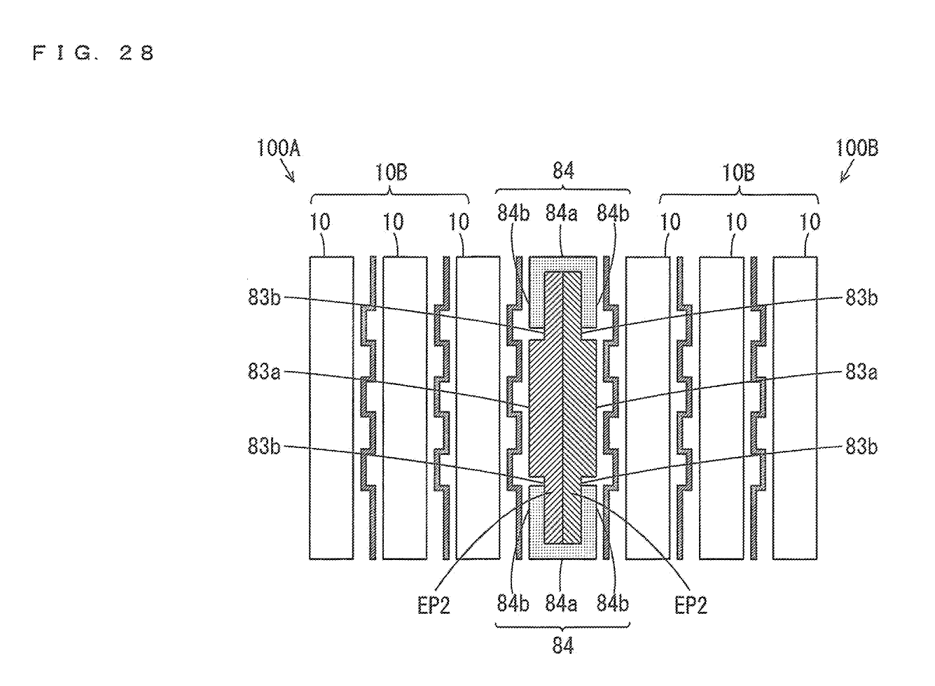

FIG. 28 is a vertical sectional view of a portion where battery modules 100A, 100B are joined in the battery system 500 according to the ninth embodiment. The four battery cell holding members 90 fix the battery blocks 10B of the battery modules 100A to 100D, respectively, in the present embodiment.

As shown in FIG. 28, the upper sides and the portions in proximity thereto of the two end surface members EP2 are sandwiched by the one sandwiching member 84. The lower sides and the portions in proximity thereto of the two end surface members EP2 are sandwiched by the other sandwiching member 84. This causes the battery cell holding member 90 of the battery module 100A and the battery cell holding member 90 of the battery module 100B to be joined. In this case, the thicknesses of the thick portion 83a and the thin portions 83b are determined in the foregoing manner, so that the inner surface of the thick portion 83a of the battery cell holding member 90 is substantially flush with the outer surfaces of the side surface portions 84b of the sandwiching members 84.

Similarly, upper sides and portions in proximity thereto of two end surface members EP2 are sandwiched by one sandwiching member 84 also in the portion where the battery modules 100C, 100D are joined. Lower sides and portions in proximity thereto of the two end surface members EP2 are sandwiched by the other sandwiching member 84. This causes the battery cell holding member 90 of the battery module 100C and the battery cell holding member 90 of the battery module 100D to be joined. The inner surface of the thick portion 83a of the battery cell holding member 90 is substantially flush with the outer surfaces of the side surface portions 84b of the sandwiching member 84.

Such a configuration eliminates the need to join the lower end of the end surface member EP2 of the battery cell holding member 90A and the lower end of the end surface member EP2 of the battery cell holding member 90B by the screws. This suppresses an increased number of assembly steps.

In each of the battery modules 100A to 100D, the end surface of the battery block 10B is fixed by the thick portion 83a of the end surface member EP2 of the battery cell holding member 90 and the side surface portions 84b of the sandwiching members 84. This does not cause stress due to expansion of the battery cells 10 of the battery modules 100A to 100D to be focused and applied on the thick portion 83a of the end surface member EP2 or the side surface portions 84b of the sandwiching members 84. This more reliably prevents the end surface members EP2 from being deformed and damaged.

While the two sandwiching members 84 are attached to cover the upper sides and the lower sides of the two end surface members EP2 in the present embodiment, the two sandwiching members 84 may be attached to cover the both lateral sides of the two end surface members EP2. In this case, the thick portion 83a is positioned at substantially the center of the end surface member EP2 in a horizontal direction. The thin portions 83b are positioned close to the both lateral sides of the end surface member EP2 to sandwich the thick portion 83a therebetween.

### [10] Tenth Embodiment

Description will be made of a battery system according to a tenth embodiment by referring to differences from the battery system 500 according to the first embodiment.

The battery block 10B is integrally fixed by the end surface member EP1 and the battery cell holding member 90 in the first embodiment. In the present embodiment, the battery block 10B is integrally fixed by a pair of battery cell holding members 90 described blow instead of the end surface member EP1 (FIG. 2) and the battery cell holding member 90 (FIG. 5).

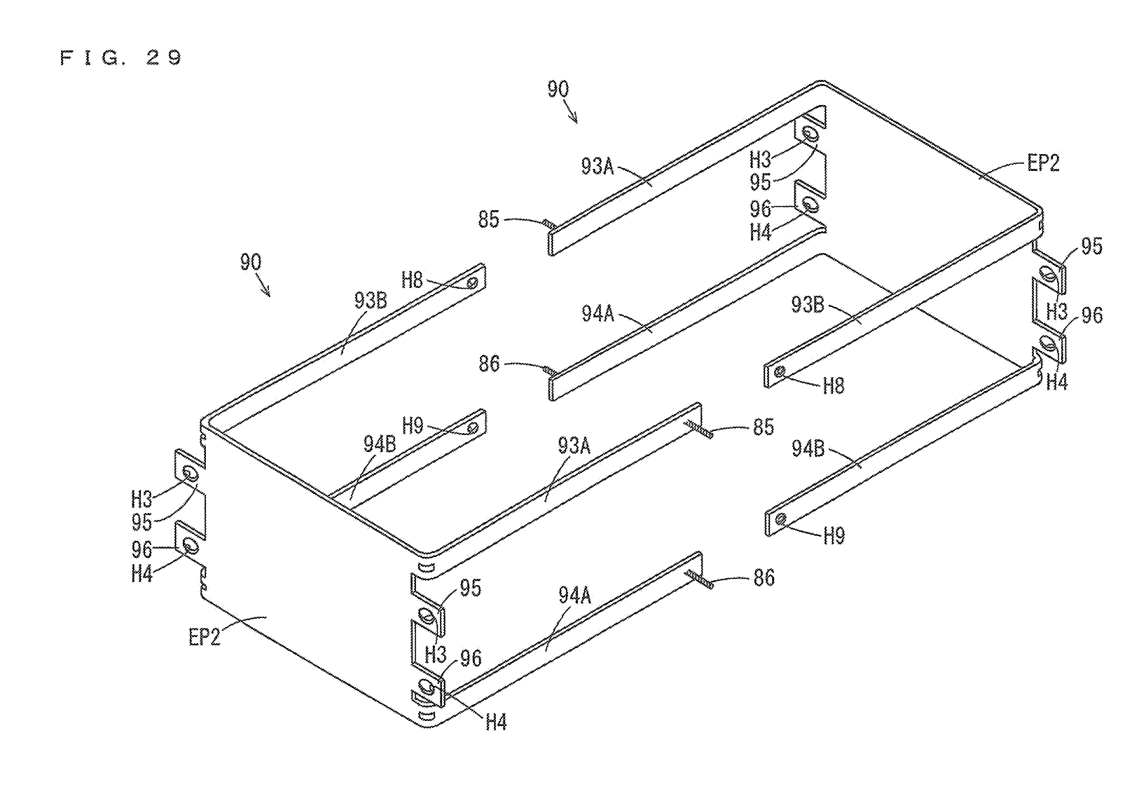

FIG. 29 is an external perspective view of the battery cell holding members 90 in the tenth embodiment. The battery cell holding members 90 of FIG. 29 are different from two battery cell holding member 90 of FIG. 5 in the following points.

As shown in FIG. 29, the battery cell holding members 90 have the same configuration. Description will be made of the configuration of one battery cell holding member 90.

In the battery cell holding member 90, a fixing member 93A is formed to extend from the upper end on one lateral side of the end surface member EP2 at a right angle to the end surface member EP2, and a fixing member 93B is formed to extend from the upper end on the other lateral side of the end surface member EP2 at a right angle to the end surface member EP2.

A fixing member 94A is formed to extend from the lower end on the one lateral side of the end surface member EP2 at a right angle to the end surface member EP2, and a fixing member 94B is formed to extend from the lower end on the other lateral side of the end surface member EP2 at a right angle to the end surface member EP2.

The length of each of the fixing members 93A, 93B, 94A, 94B is about half the length of each of the fixing members 93, 94 of FIG. 5. Unlike the fixing members 93, 94 of FIG. 5, the tips of the fixing members 93A, 93B, 94A, 94B are not bent.

Here, male screws 85, 86 are formed to project outward at the tips of the fixing members 93A, 94A, respectively, extending from the one lateral side of the end surface member EP2. Holes H8, H9 are formed at the tips of the fixing members 93B, 94B, respectively, extending from the other lateral side of the end surface member EP2.

Similarly to the battery cell holding member 90 of FIG. 5, the pair of fastening portions 95 and the pair of fastening portions 96 are formed to project from the both lateral sides of the end surface member EP2 in the battery cell holding member 90.

As shown in FIG. 29, the pair of battery cell holing members 90 is arranged such that the inner surfaces of the end surface members EP2 are opposite to each other for fixing the battery block 10B. The battery block 10B is arranged between the pair of battery cell holding members 90. FIG. 29 does not show the battery block 10B.

In this state, the male screws 85, 86 of the fixing members 93A, 94A of the one battery cell holding member 90 are inserted in the holes H8, H9 of the fixing members 93B, 94B of the other battery cell holding member 90, respectively. Nuts, not shown, are then attached to the male screws 85, 86, so that the fixing members 93A, 94A of the one battery cell holding member 90 and the fixing members 93B, 94B of the other battery cell holding member 90 are joined to each other.

Similarly, the male screws 85, 86 of the fixing members 93A, 94A of the other battery cell holding member 90 are inserted in the holes H8, H9 of the fixing members 93B, 94B of the one battery cell holding member 90, respectively. Nuts, not shown, are then attached to the male screws 85, 86, so that the fixing members 93A, 94A of the other battery cell holding member 90 and the fixing members 93B, 94B of the one battery cell holding member 90 are joined to each other.

Accordingly, the battery block 10B is integrally fixed while being sandwiched between the pair of battery cell holding members 90.

As described above, the both ends of the battery block 10B are fixed by the end surface members EP2 each formed of the rectangular plate when the pair of battery cell holding members 90 is used. That is, the end surface members EP2 are arranged at the both ends of the battery module 100.

This allows an end surface member EP2 of another battery module 100 to be joined to the one end surface member EP2 of the battery module 100. Moreover, an end surface member EP2 of still another battery module 100 can be joined to the other end surface member EP2 of the battery module 100. As a result, the battery block 10B of each of the battery modules 100 can be fixed with three or more battery modules 100 arranged in a line.

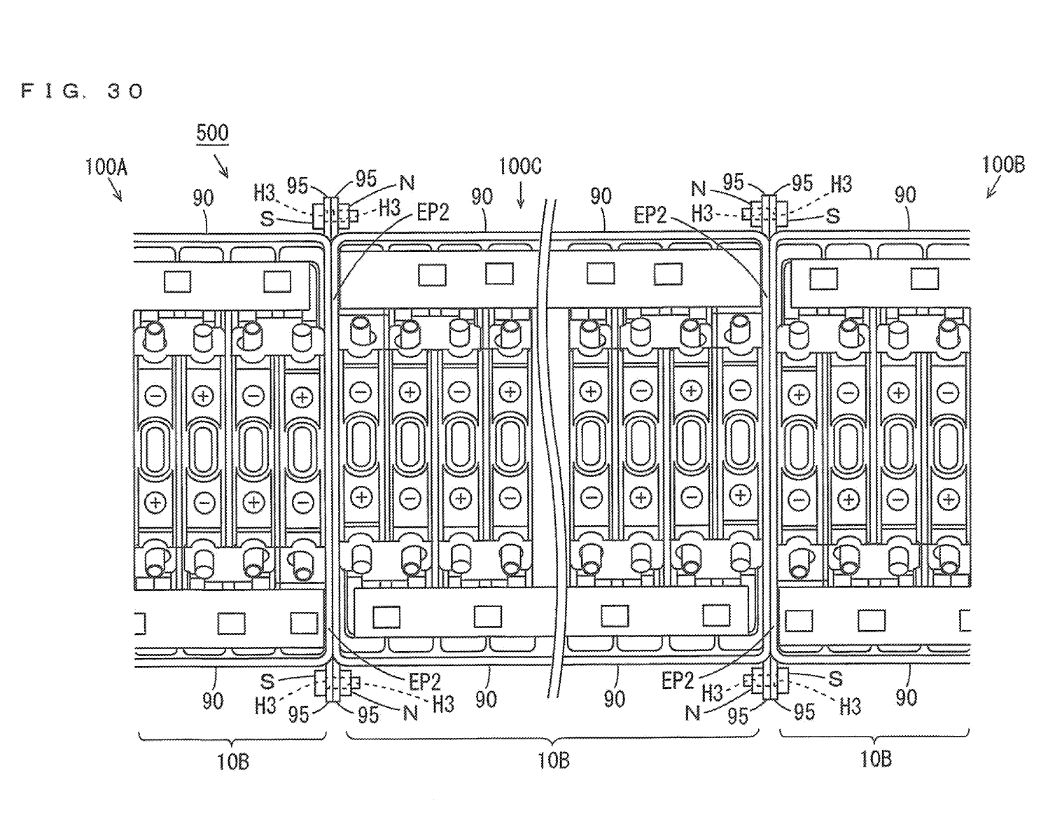

FIG. 30 is an enlarged plan view of portions where battery modules 100A, 100B, 100C are joined in the battery system 500 according to the tenth embodiment.

In the example of FIG. 30, the three battery modules 100A, 100B, 100C are joined to one another while being arranged in a line. The battery block 10B is integrally fixed by the pair of battery cell holding members 90 of FIG. 29 in the battery module 100C. In each of the battery modules 100A, 100B, the battery block 10B is integrally fixed by the end surface member EP1 and the battery cell holding member 90 used in the first embodiment.

As shown in FIG. 30, with the end surface member EP2 of the battery module 100A and one end surface member EP2 of the battery module 100C being in contact with each other, the screws S are inserted in the holes H3, H4 of the fastening portions 95, 96 (see FIG. 5), and the one fastening portions 95, 96 are joined to the other fastening portions 95, 96, respectively, by the screws and the nuts N.

This causes the end surface member EP2 of the battery module 100A and the one end surface member EP2 of the battery module 100C to be joined while being in contact with each other. Similarly, the end surface member EP2 of the battery module 100B and the other end surface member EP2 of the battery module 100C are joined while being in contact with each other.

As described above, using the pair of battery cell holding members 90 of FIG. 29 allows the three battery modules 100A to 100C or more battery modules to be arranged in a line with the end surface members EP2 being in contact with one another. Accordingly, increased capacity of the battery system 500 can be realized while the battery system 500 can be further reduced in size and weight.

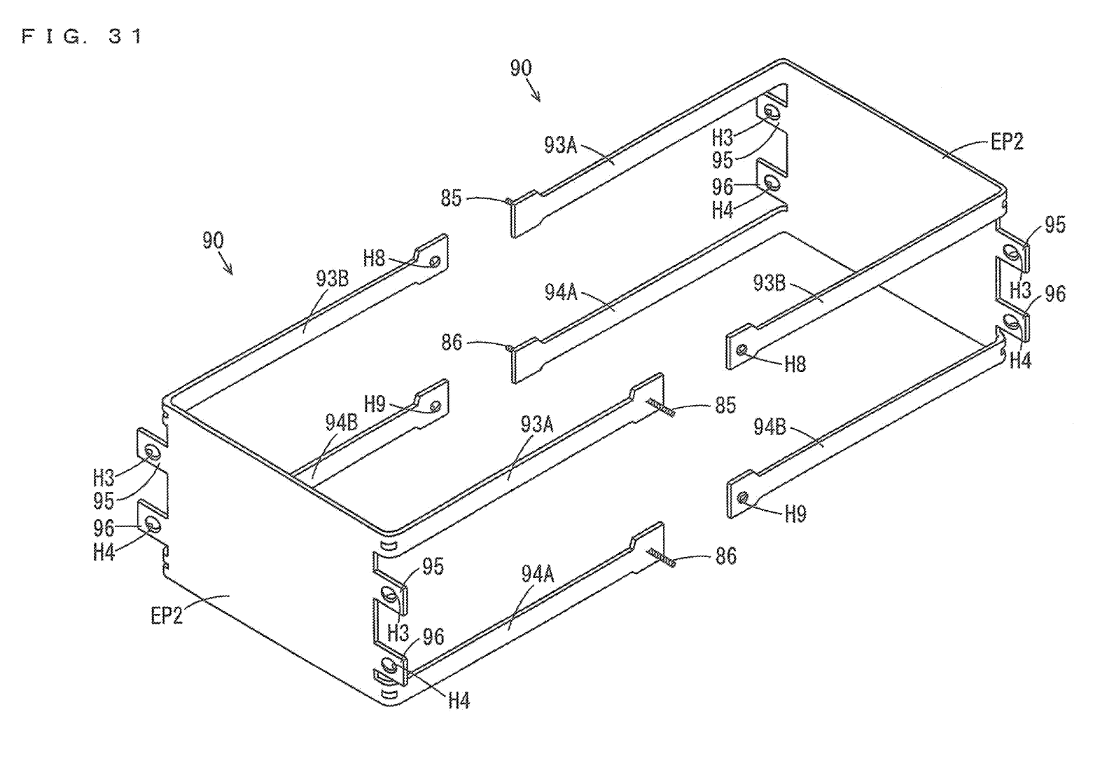

FIG. 31 is an external perspective view showing another example of the battery cell holding members in the tenth embodiment. As shown in FIG. 31, a wide portion may be formed at the tip of each of the fixing members 93A, 93B, 94A, 94B of the battery cell holding members 90. This sufficiently prevents the tips of the fixing members 93A, 93B, 94A, 94B from being deformed and damaged even when large stress is exerted on the tips of the fixing members 93A, 93B, 94A, 94B.

### [11] Eleventh Embodiment

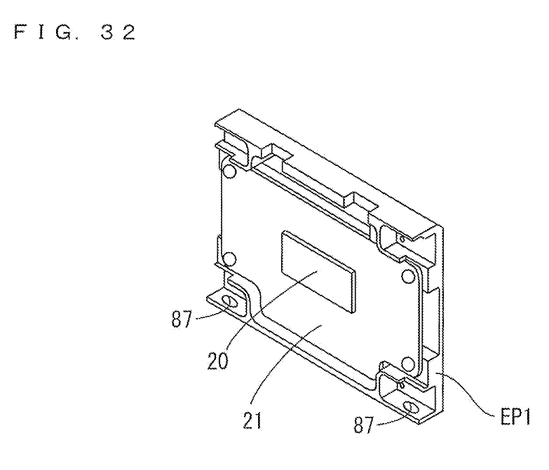

Description will be made of a battery system according to an eleventh embodiment by referring to differences from the battery system 500 according to the first embodiment. In the present embodiment, an end surface member EP1 described below is employed instead of the end surface member EP1 of FIG. 2. FIG. 32 is an external perspective view of the end surface member EP1 in the eleventh embodiment. The end surface member EP1 of FIG. 32 is different from the end surface member EP1 of FIG. 2 in the following points.

As shown in FIG. 32, two screw holes 87 are formed at a given spacing on a lower surface (surface arranged on the bottom surface portion 550e of the casing 550 of FIG. 11) in the end surface member EP1.

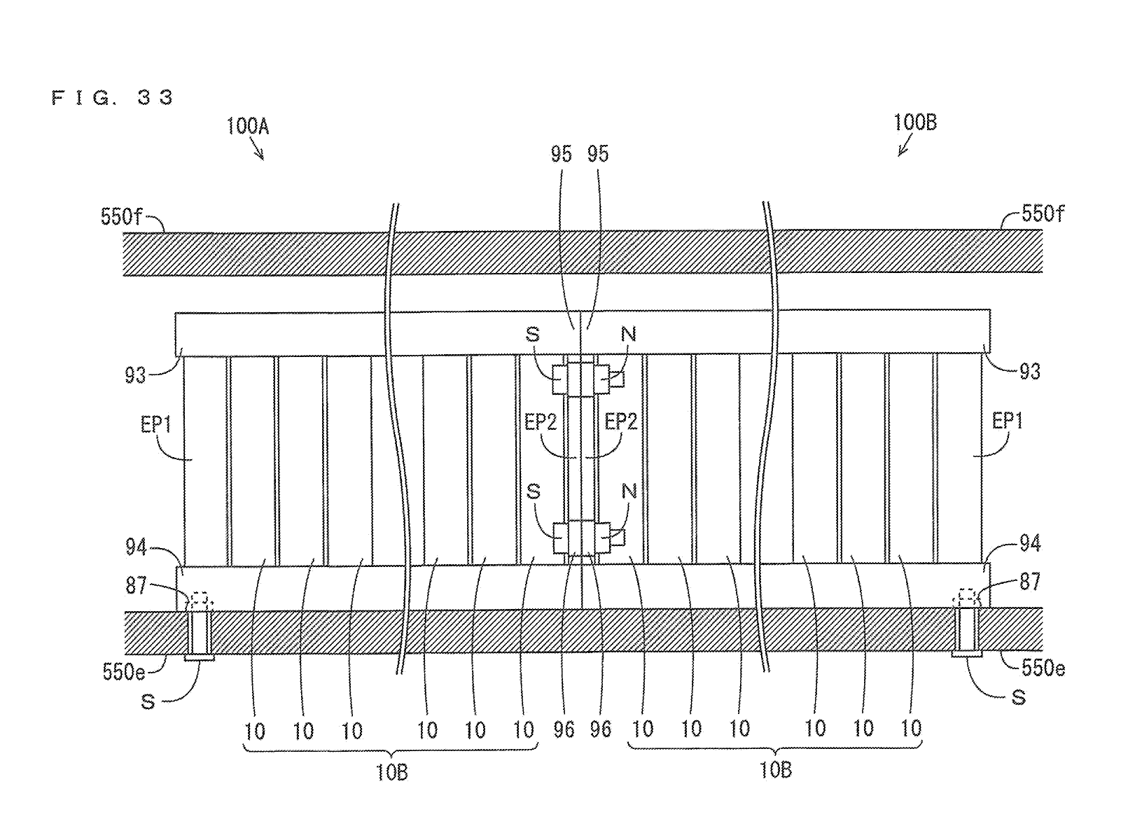

FIG. 33 is a side view of a portion where battery modules 100A, 100B are joined in the battery system 500 (see FIG. 11) according to the eleventh embodiment. As shown in FIG. 33, the end surface member EP2 of the battery module 100A and the end surface member EP2 of the battery module 100B are joined in the same manner as in the first embodiment (see FIG. 12).

In this state, the two screws S are fitted in the respective screw holes 87 formed in the lower surface of the end surface member EP1 of the battery module 100A via through holes of the bottom surface portion 550e of the casing 550 (see FIG. 11). The two screws S are fitted in the respective screw holes 87 formed in the lower surface of the end surface member EP1 of the battery module 100B via through holes of the bottom surface portion 550e of the casing 550. Accordingly, the end surface member EP2 of the battery module 100A and the end surface member EP2 of the battery module 100B are joined while being in contact with each other, and each of the battery modules 100A, 100B is fixed to the bottom surface portion 550e of the casing 550. This more reliably prevents the end surface members EP2 from being deformed and damaged.

Similarly, the end surface member EP2 of the battery module 100C and the end surface member EP2 of the battery module 100D are joined, and each of the battery modules 100C, 100D is fixed to the bottom surface portion 550e of the casing 550. This more reliably prevents the end surface members EP2 from being deformed and damaged.

While each of the battery modules 100A to 100D includes the battery cell holding member 90 of the first embodiment in the present embodiment, the present invention is not limited to this. The battery modules 100A to 100D may include the battery cell holding members 90 of any of the second to ninth embodiments instead of the battery cell holding members 90 of the first embodiment.

### [12] Twelfth Embodiment

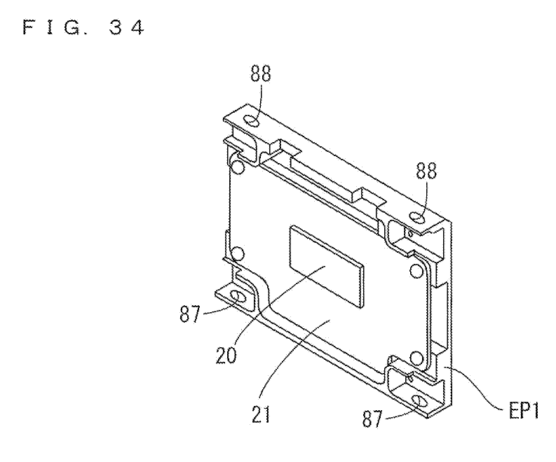

Description will be made of a battery system according to a twelfth embodiment by referring to differences from the battery system 500 according to the eleventh embodiment. In the present embodiment, an end surface member EP1 described below is employed instead of the end surface member EP1 of FIG. 32. FIG. 34 is an external perspective view of the end surface member EP1 in the twelfth embodiment. The end surface member EP1 of FIG. 34 is different from the end surface member EP1 of FIG. 32 in the following points.

As shown in FIG. 34, in the end surface member EP1, the two screw holes 87 are formed at the given spacing on the lower surface (surface arranged on the bottom surface portion 550e of the casing 550 of FIG. 11) and two screw holes 88 are formed at a given spacing on an upper surface (surface opposed to the cover 550f of the casing 550 of FIG. 16).

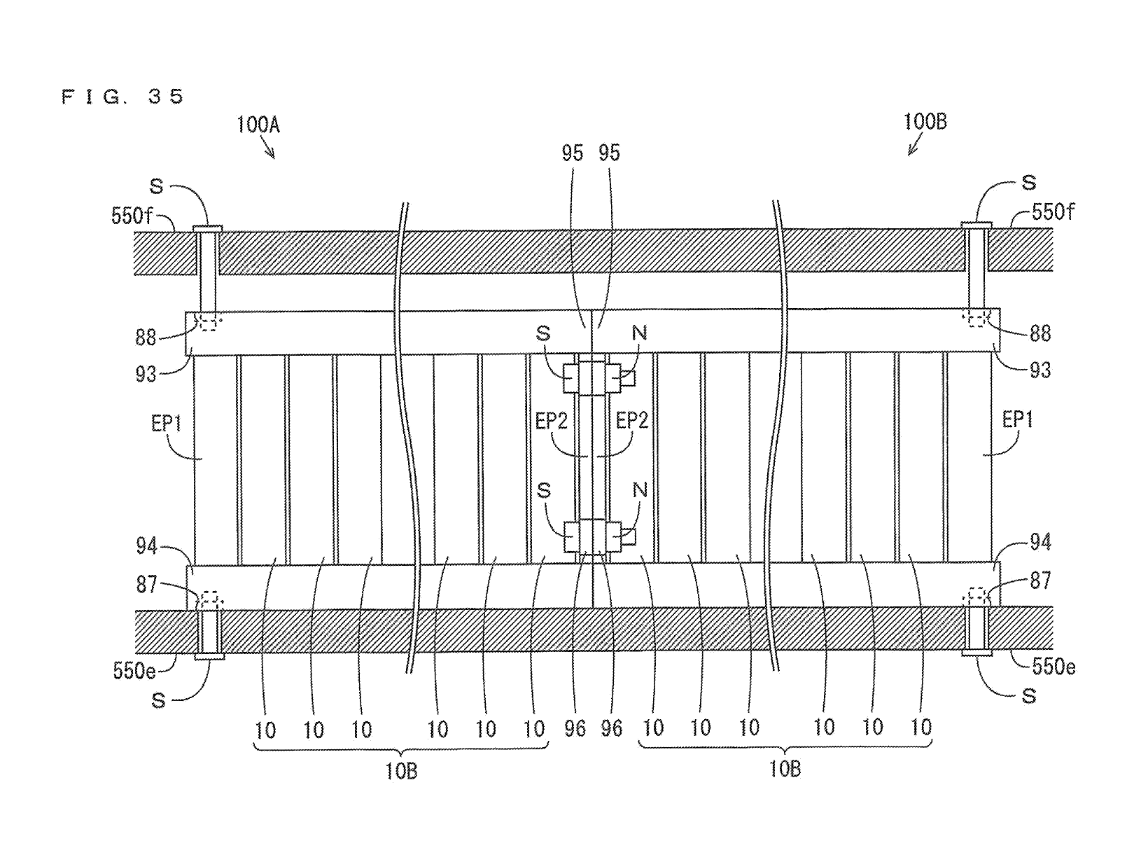

FIG. 35 is a side view of a portion where battery modules 100A, 100B are joined in the battery system 500 (see FIG. 11) according to the twelfth embodiment. As shown in FIG. 35, the end surface member EP2 of the battery module 100A and the end surface member EP2 of the battery module 100B are joined while being in contact with each other, and each of the battery modules 100A, 100B is fixed to the bottom surface portion 550e of the casing 550 in the same manner as in the eleventh embodiment (see FIG. 33).

The two screws S are fitted in the respective screw holes 88 formed in the upper surface of the end surface member EP1 of the battery module 100A via the through holes of the cover 550f of the casing 550. The two screws S are fitted in the respective screw holes 88 formed in the upper surface of the end surface member EP1 of the battery module 100B via the through holes of the cover 550f of the casing 550. Accordingly, each of the battery modules 100A, 100B is fixed to the cover 550f of the casing 550. This further reliably prevents the end surface members EP2 from being deformed and damaged.

Similarly, the end surface member EP2 of the battery module 100C and the end surface member EP2 of the battery module 100D are joined to each other, and each of the battery modules 100C, 100D is fixed to the bottom surface portion 550e and the cover 550f of the casing 550. This further reliably prevents the end surface members EP2 from being deformed and damaged.

While each of the battery modules 100A to 100D includes the battery cell holding member 90 of the first embodiment in the present embodiment, the present invention is not limited to this. The battery modules 100A to 100D may include the battery cell holding members 90 of any of the second to ninth embodiments instead of the battery cell holding members 90 of the first embodiment.

### [13] Thirteenth Embodiment

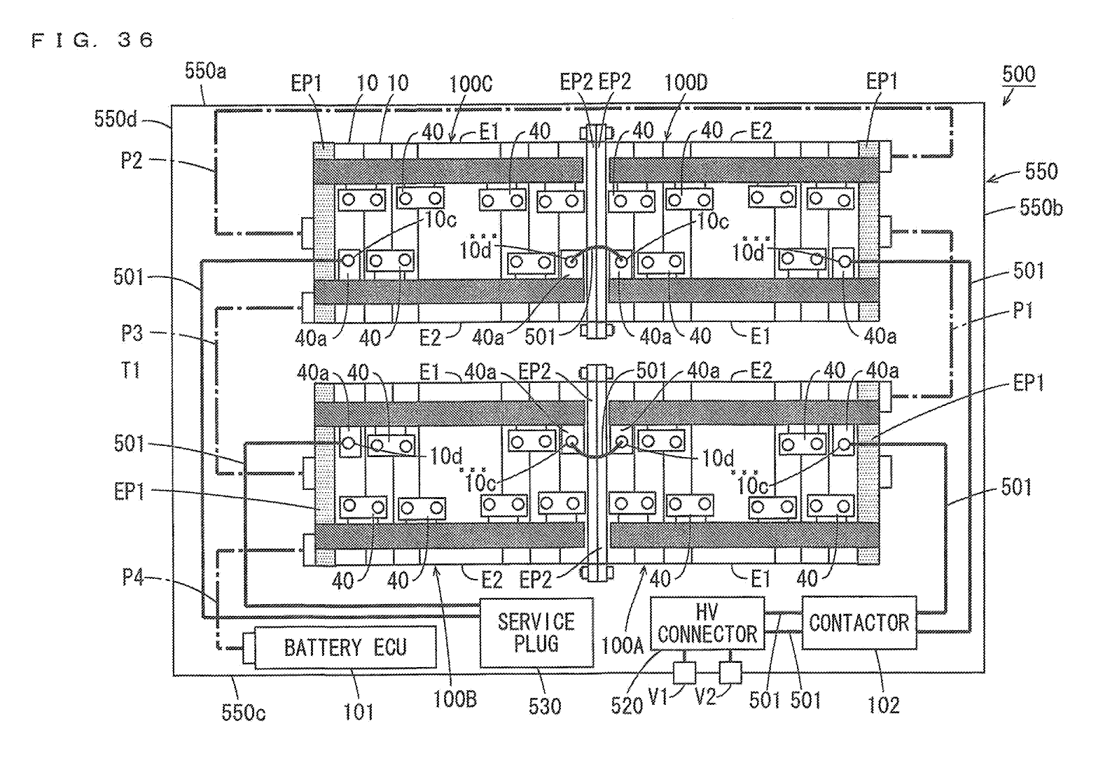

Description will be made of a battery system according to a thirteenth embodiment by referring to differences from the battery system 500 according to the first embodiment. FIG. 36 is a schematic plan view showing one example of connection and wiring of battery modules 100A to 100D in the battery system 500 according to the thirteenth embodiment. The battery system 500 of FIG. 36 is different from the battery system 500 of FIG. 11 in the following points.

The battery system 500 according to the present embodiment includes the battery modules 100A to 100D, the contactor 102, an HV (High Voltage) connector 520 and a service plug 530.

The end surface member EP2 of the battery module 100A and the end surface member EP2 of the battery module 100B are arranged to be in contact with each other, and the end surface member EP2 of the battery module 100C and the end surface member EP2 of the battery module 100D are arranged to be in contact with each other. The side surface E2 of the battery module 100A and the side surface E1 of the battery module 100D are arranged to be opposite to each other, and the side surface E1 of the battery module 100B and the side surface E2 of the battery module 100C are arranged to be opposite to each other. The end surface member EP1 of the battery module 100A and the end surface member EP1 of the battery module 100D are arranged to be directed to the side wall 550b, and the end surface member EP1 of the battery module 100B and the end surface member EP1 of the battery module 100C are arranged to be directed to the side wall 550d.

The battery ECU 101, the service plug 530, the HV connector 520 and the contactor 102 are arranged to line up in this order from the side wall 550d toward the side wall 550b in a region between the side surfaces E1, E2 of the battery modules 100A, 100B and the side wall 550c. The HV connector 520 includes the voltage terminals V1, V2. The voltage terminals V1, V2 of the HV connector 520 are provided on the side wall 550c.

In each of the battery modules 100A, 100C, the potential of the plus electrode 10a (see FIG. 3) of the battery cell 10 adjacent to the end surface member EP1 is the highest, and the potential of the minus electrode 10b (see FIG. 3) of the battery cell 10 adjacent to the end surface member EP2 is the lowest. In each of the battery modules 100B, 100D, the potential of the plus electrode 10a of the battery cell 10 adjacent to the end surface member EP2 is the highest, and the potential of the minus electrode 10b of the battery cell 10 adjacent to the end surface member EP1 is the lowest. Hereinafter, the plus electrode 10a having the highest potential in each of the battery modules 100A to 100D is referred to as a high potential electrode 10c, and the minus electrode 10b having the lowest potential in each of the battery modules 100A to 100D is referred to as a low potential electrode 10d.

In each of the battery modules 100A, 100C, the bus bars 40, 40a are connected to the plurality of battery cells 10 such that the high potential electrode 10c and the low potential electrode 10d are arranged close to the side surface E2. In each of the battery modules 100B, 100D, the bus bars 40, 40a are connected to the plurality of battery cells 10 such that the high potential electrode 10c and the low potential electrode 10d are arranged close to the side surface E1.

The low potential electrode 10d of the battery module 100A and the high potential electrode 10c of the battery module 100B are connected through the power supply line 501. The low potential electrode 10d of the battery module 100C and the high potential electrode 10c of the battery module 100D are connected through the power supply line 501. The low potential electrode 10d of the battery module 100B is connected to the service plug 530 through the power supply line 501, and the high potential electrode 10c of the battery module 100C is connected to the service plug 530 through the power supply line 501.

The service plug 530 is turned off by a worker during maintenance of the battery system 500, for example. When the service plug 530 is turned off, a series circuit composed of the battery modules 100A, 100B and a series circuit composed of the battery modules 100C, 100D are electrically separated from each other. In this case, the current path among the four battery modules 100A to 100D is cut off. This provides a high degree of safety during maintenance.

The contactor 102 as well as the service plug 530 is turned off by a worker during maintenance of the battery system 500. In this case, the current path among the four battery modules 100A to 100D is reliably cut off. This sufficiently provides a high degree of safety during maintenance. When the battery modules 100A to 100D have equal voltages, the total voltage of the series circuit composed of the battery modules 100A, 100B is equal to the total voltage of the series circuit composed of the battery modules 100C, 100D. This prevents a high voltage from being generated in the battery system 500 during maintenance.

The high potential electrode 10c of the battery module 100A is connected to the voltage terminal V1 of the HV connector 520 through the power supply line 501 via the contactor 102. The low potential electrode 10d of the battery module 100D is connected to the voltage terminal V2 of the HV connector 520 through the power supply line 501 via the contactor 102. In this case, the motor or the like of the electric vehicle is connected between the voltage terminals V1, V2, so that electric power generated in the battery modules 100A to 100D connected in series can be supplied to the motor or the like.

The detecting circuit 20 (see FIG. 2) of the battery module 100A and the detecting circuit 20 of the battery module 100D are connected to each other through a communication line P1. The detecting circuit 20 of the battery module 100D and the detecting circuit 20 of the battery module 100C are connected to each other through a communication line P2. The detecting circuit 20 of the battery module 100C and the detecting circuit 20 of the battery module 100B are connected to each other through a communication line P3. The detecting circuit 20 of the battery module 100B and the battery ECU 101 are connected to each other through a communication line P4. The communication lines P1 to P4 constitute the bus 103 of FIG. 1.

The battery modules 100A to 100D are arranged in the foregoing manner, thereby sufficiently preventing the end surface members EP2 from being deformed and damaged and reducing the lengths of the plurality of power supply lines 501 and the communication lines P1 to P4. This allows for reduced size and weight of the battery system 500.

### [14] Fourteenth Embodiment

Description will be made of an electric vehicle according to a fourteenth embodiment. The electric vehicle according to the present embodiment includes the battery system according to any of the first to thirteenth embodiments. In the following paragraphs, an electric automobile is described as one example of the electric vehicle.

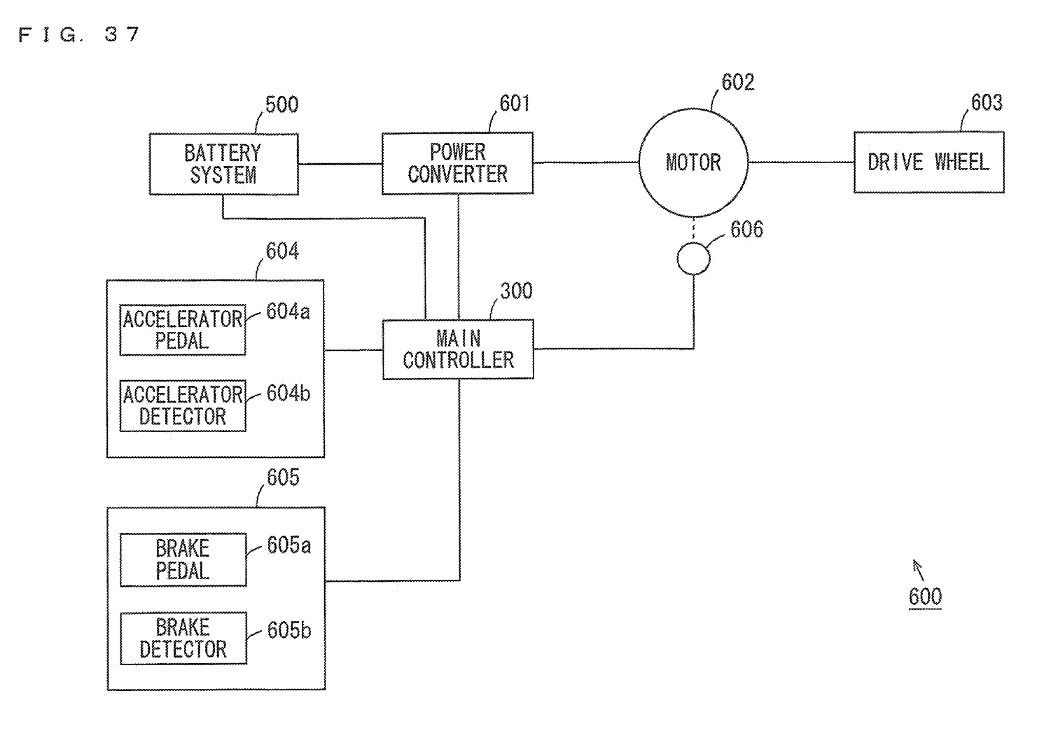

FIG. 37 is a block diagram showing the configuration of the electric automobile including the battery system 500. As shown in FIG. 37, the electric automobile 600 according to the present embodiment includes the battery system 500, the main controller 300, a power converter 601, a motor 602, drive wheels 603, an accelerator system 604, a brake system 605, and a rotational speed sensor 606. When the motor 602 is an alternating current (AC) motor, the power converter 601 includes an inverter circuit.

The battery system 500 is connected to the motor 602 via the power converter 601 while being connected to the main controller 300 in the present embodiment. Each of the accelerator system 604, the brake system 605 and the rotational speed sensor 606 is connected to the main controller 300. The main controller 300 is composed of a CPU and a memory or composed of a microcomputer, for example.

The accelerator system 604 includes an accelerator pedal 604a included in the electric automobile 600 and an accelerator detector 604b that detects an operation amount (depression amount) of the accelerator pedal 604a. When the accelerator pedal 604a is operated by a driver, the accelerator detector 604b detects the operation amount of the accelerator pedal 604a. Note that a state of the accelerator pedal 604a when not being operated by the driver is set as a reference. The detected operation amount of the accelerator pedal 604a is applied to the main controller 300.

The brake system 605 includes a brake pedal 605a provided in the electric automobile 600 and a brake detector 605b that detects an operation amount (depression amount) of the brake pedal 605a by the driver. When the brake pedal 605a is operated by the driver, the operation amount is detected by the brake detector 605b. The detected operation amount of the brake pedal 605a is applied to the main controller 300.

The rotational speed sensor 606 detects a rotational speed of the motor 602. The detected rotational speed is applied to the main controller 300.

The voltage, current and temperature of the battery modules 100, the operation amount of the accelerator pedal 604a, the operation amount of the brake pedal 605a and the rotational speed of the motor 602 are applied to the main controller 300. The main controller 300 performs charge/discharge control of the battery modules 100 and power conversion control by the power converter 601 based on the information.

Electric power generated by the battery modules 100 is supplied from the battery system 500 to the power converter 601 at the time of start-up and acceleration of the electric automobile 600 based on the accelerator operation, for example.

Furthermore, the main controller 300 calculates a torque (commanded torque) to be transmitted to the drive wheels 603 based on the applied operation amount of the accelerator pedal 604a, and applies a control signal based on the commanded torque to the power converter 601.

The power converter 601 receives the control signal, and then converts the electric power supplied from the battery system 500 into electric power (driving power) required for driving the drive wheels 603. Accordingly, the driving power converted by the power converter 601 is supplied to the motor 602, and the torque of the motor 602 based on the driving power is transmitted to the drive wheels 603.

Meanwhile, the motor 602 functions as a power generation system at the time of deceleration of the electric automobile 600 based on the brake operation. In this case, the power converter 601 converts regenerated electric power generated by the motor 602 to electric power suitable for charging the battery modules 100, and supplies the electric power to the battery modules 100. This causes the battery modules 100 to be charged.

As described above, the electric automobile 600 according to the present embodiment is provided with the battery system according to any of the first to thirteenth embodiments. Thus, the electric automobile 600 can be reduced in size and weight. In addition, an increase in manufacturing cost of the electric automobile 600 can be suppressed.

### [15] Other Embodiments

(1) While the fixing members 93, 94 or the fixing members 93A, 93B, 94A, 94B are integrally formed with the end surface member EP2 in the battery cell holding members 90, 90A, 90B used in the first to thirteenth embodiments, the present invention is not limited to this. The fixing members 93, 94 or the fixing members 93A, 93B, 94A, 94B may be formed separately from the end surface member EP2. In this case, the fixing members 93, 94 or the fixing members 93A, 93B, 94A, 94B may be fixed to the end surface member EP2 by screws or the like, or may be fixed to the end surface member EP2 by welding.

(2) While the two end surface members EP2 being in contact with each other are joined by using the screws S and the nuts N in combination, using the concave portion 81a and the latch portion 81b in combination, using the insertion holes 82a and the latch portions 82b in combination or using the sandwiching member 84 in the first to thirteenth embodiments, the present invention is not limited to this. For example, the two end surface members EP2 being in contact with each other may be joined by welding.

(3) While the plurality of bus bars 40, 40a are attached to the plus electrodes 10a or the minus electrodes 10b of the plurality of battery cells 10 by the nuts in the first to thirteenth embodiments, the present invention is not limited to this. The plurality of bus bars 40, 40a may be attached to the plus electrodes 10a or the minus electrodes 10b of the plurality of battery cells 10 by welding or the like.

(4) While the battery cells 10 each having the substantially rectangular parallelepiped shape are used in the first to thirteenth embodiments, the present invention is not limited to this. For example, a battery cell having a cylindrical shape may be used, or a laminate type battery cell may be used instead of the battery cell 10 having the substantially rectangular parallelepiped shape.

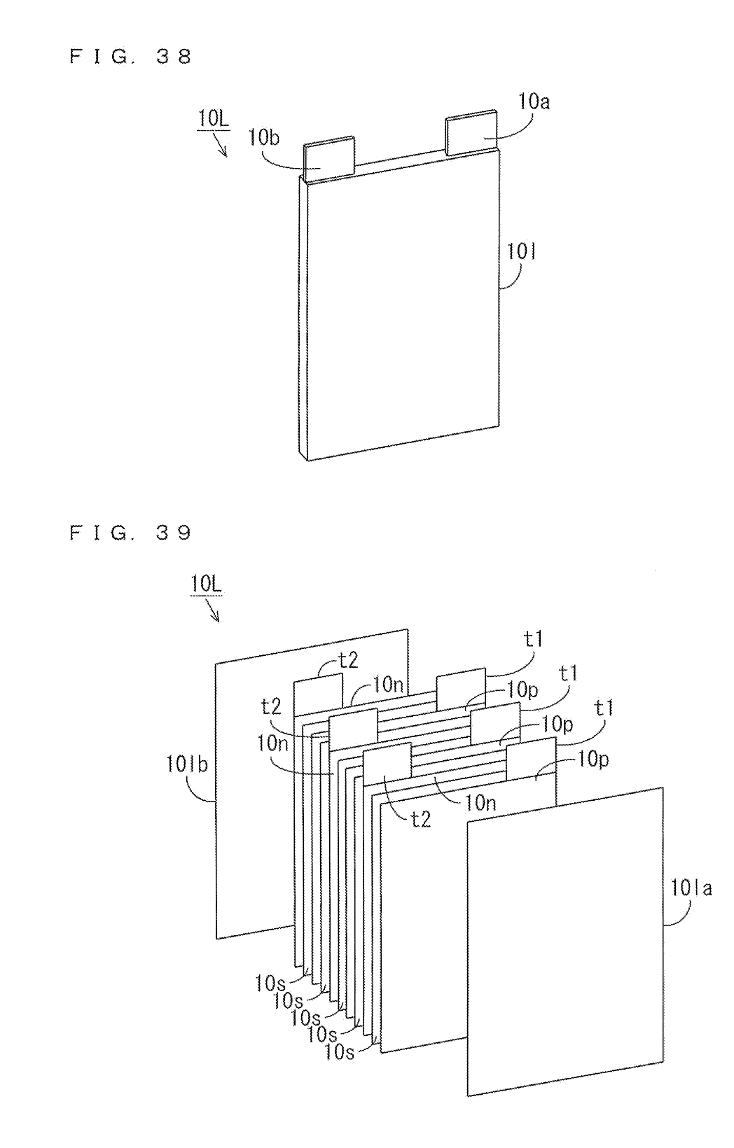

FIG. 38 is an external perspective view of a laminate type battery cell, and FIG. 39 is an exploded perspective view of the laminate type battery cell 10L of FIG. 38. As shown in FIG. 38, the battery cell 10L has a thin rectangular container 10I made of laminate films. The plus electrode 10a and the minus electrode 10b are drawn out from one end side of the container 101.

As shown in FIG. 39, the battery cell 10L includes a plurality of pairs (three pairs in the example of FIG. 39) of positive electrodes 10p and negative electrodes 10n having positive electrode tabs t1 and negative electrode tabs t2, respectively, a plurality of (five in the example of FIG. 39) separators 10s and the pair of laminate films 10Ia, 10Ib. The plurality of positive electrodes 10p and negative electrodes 10n are alternately stacked. The separator 10s is inserted between the stacked positive electrode 10p and negative electrode 10n. The plurality of pairs of positive electrodes 10p and negative electrodes 10n that are stacked are accommodated in the container 10I (see FIG. 38) formed by the pair of laminate films 10Ia, 10Ib, and an electrolytic solution is filled in the container 10I. The plurality of positive electrode tabs t1 are drawn out of the container 10I to be integrally connected to the plus electrode 10a (see FIG. 38). The plurality of negative electrode tabs t2 are drawn out of the container 10I to be integrally connected to the minus electrode 10b (see FIG. 38).

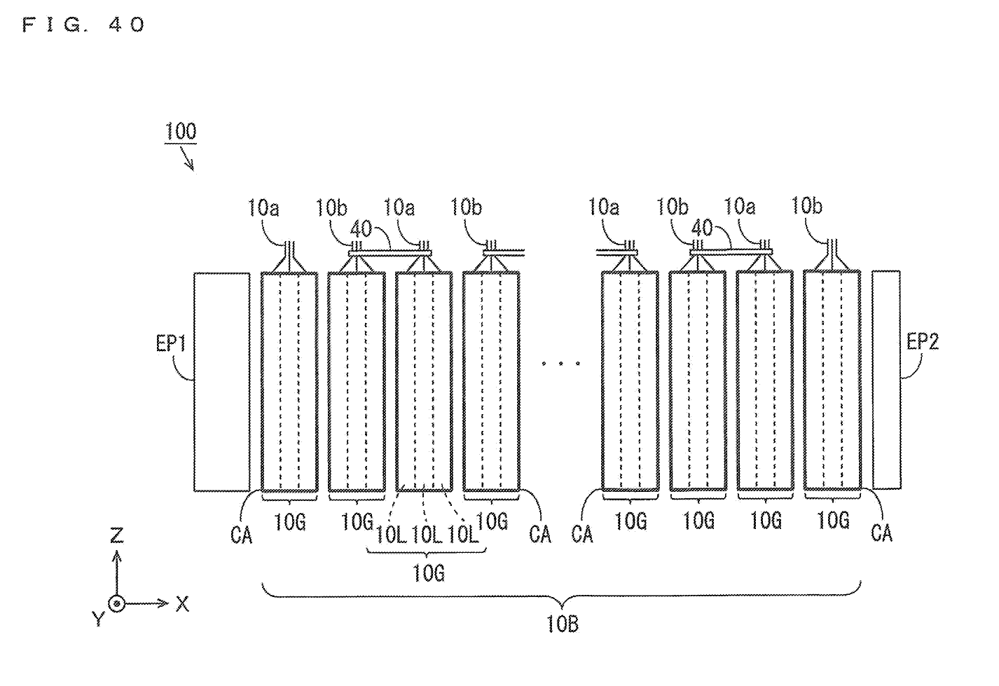

FIG. 40 is a side view of a battery module 100 using the laminate type battery cells 10L of FIG. 38. In FIG. 40, the plurality of (three in the example of FIG. 40) battery cells 10L are connected in parallel to constitute one parallel cell group 10G. The one parallel cell group 10G is accommodated in a case CA to be integrated. The plurality of plus electrodes 10a and the plurality of minus electrodes 10b are integrated to be drawn out from an upper end of the case CA.

The battery module 100 is constituted by a plurality of parallel cell groups 10G. The plurality of parallel cell groups 10G are stacked in the X-direction. In this state, the parallel cell groups 10G are arranged such that the positional relationship between the plus electrode 10a and the minus electrode 10b of the parallel cell group 10G in the Y-direction is opposite to that of the adjacent parallel cell group 10G. One electrodes 10a, 10b of the plurality of parallel cell groups 10G are arranged to form a line along the X-direction, and the other electrodes 10a, 10b of the plurality of parallel cell groups 10G are arranged to form a line along the X-direction.

Thus, in two adjacent parallel cell groups 10G, the plus electrode 10a of one parallel cell group 10G is in close proximity to the minus electrode 10b of the other parallel cell group 10G, and the minus electrode 10b of the one parallel cell group 10G is in close proximity to the plus electrode 10a of the other parallel cell group 10G. In this state, the bus bar 40 is attached to the two electrodes 10a, 10b being in close proximity to each other. This causes the plurality of parallel cell groups 10G to be connected in series.

The battery block 10B composed of the plurality of parallel cell groups 10G connected in series is integrally fixed by the end surface members EP1, EP2. In this manner, the battery module 100 is configured to include the plurality of laminate type battery cells 10L.

Similarly to the battery cells 10, the laminate type battery cells 10L have the property of expanding due to repetitive charge/discharge for a long period of time. Even in such a case, stress exerted on the end surface members EP2 of the battery modules 100A, 100C (see FIG. 11) and stress exerted on the end surface members EP2 of the battery modules 100B, 100D (see FIG. 11) cancel each other out. Therefore, the end surface members EP2 are sufficiently prevented from being deformed and damaged even when the thicknesses of the end surface members EP2 are small. This allows for reduced size and weight of the battery system 500.

(5) While the thickness of each of the end surface members EP1 is larger than the thickness of each of the end surface members EP2 in the first to thirteenth embodiments, the present invention is not limited to this. When the end surface members EP1 are formed of a high-strength material, for example, the thickness of each of the end surface members EP1 may not be larger than the thickness of each of the end surface members EP2. Also in this case, the end surface members EP1 are sufficiently prevented from being deformed and damaged.

(6) While the end surface member EP2 has the smaller thickness than the end surface member EP1 in the first to thirteenth embodiments, the present invention is not limited to this. For example, in two adjacent battery modules 100, the end surface member EP2 of one battery module 100 may have a thickness not smaller than that of the end surface member EP1, and the end surface member EP2 of the other battery module 100 may have a thickness smaller than that of the end surface member EP1. In this case, the weight of the other battery module 100 can be reduced, and the end surface member EP2 of the other battery module 100 can be sufficiently prevented from being deformed and damaged.

(7) The present invention can effectively be used for various mobile objects using electric power as driving sources, power storage devices, mobile devices or the like.

### [16] Correspondences Between Elements in the Claims and Parts in Embodiments

In the following paragraph, non-limiting examples of correspondences between various elements recited in the claims below and those described above with respect to various preferred embodiments of the present invention are explained.

The battery cell 10, 10L is an example of each of first and second battery cells, and the battery block 10B is an example of each of first and second battery blocks. The end surface member EP2 of the battery cell holding member 90 or the end surface member EP2 of the battery cell holding member 90B is an example of a first end surface member, and the end surface member EP2 of the battery cell holding member 90 or the end surface member EP2 of the battery cell holding member 90A is an example of a second end surface member. The end surface member EP1 is an example of each of third and fourth end surface members, the battery system 500 is an example of a battery system, and the casing 550 is an example of a casing. The screw S and the nut N, the concave portion 81a and the latch portion 81b, the insertion hole 82a and the latch portion 82b, or the sandwiching member 84 is an example of a joining member, and the holes H3, H4, H5, H6, or H7 is an example of a hole. The screw S is an example of a screw member, the sandwiching member 84 is an example of a sandwiching member, and the latch portion 81b or the latch portion 82b is an example of a latch member. The motor 602 is an example of a motor, the drive wheel 603 is an example of a drive wheel, and the electric automobile 600 is an example of an electric vehicle.

As each of various elements recited in the claims, various other elements having configurations or functions described in the claims can be also used.

While preferred embodiments of the present invention have been described above, it is to be understood that variations and modifications will be apparent to those skilled in the art without departing the scope and spirit of the present invention. The scope of the present invention, therefore, is to be determined solely by the following claims.

I/We claim:

1. A battery system comprising:
a first battery block including a plurality of first battery cells that are stacked;
a second battery block including a plurality of second battery cells that are stacked;
a first end surface member arranged so as to be stacked on the first battery cell positioned at one end of said first battery block in a direction in which said plurality of first battery cells are stacked; and
a second end surface member arranged so as to be stacked on the second battery cell positioned at one end of said second battery block in a direction in which said plurality of second battery cells are stacked, wherein
said first battery block and said second battery block are fixed to each other with said first end surface member and said second end surface member being in contact with each other.

2. The battery system according to claim 1, further comprising a casing that accommodates said first and second battery blocks, wherein
said first and second battery blocks are fixed to said casing with said first end surface member and said second end surface member being in contact with each other.

3. The battery system according to claim 1, further comprising a joining member that joins said first end surface member and said second end surface member to each other.

4. The battery system according to claim 3, wherein
said first and second end surface members have respective holes, and
said joining member includes a screw member to be inserted in the respective holes of said first and second end surface members.

5. The battery system according to claim 3, wherein said joining member includes a sandwiching member that joins said first and second end surface members to each other by sandwiching said first and second end surface members.

6. The battery system according to claim 3, wherein said joining member includes a latch member that is provided in said first end surface member and that latches said second end surface member.

7. The battery system according to claim 1, further comprising:
a third end surface member arranged so as to be stacked on the first battery cell positioned at the other end on the opposite side to said one end of said first battery block in the direction in which said plurality of first battery cells of said first battery block are stacked; and
a fourth end surface member arranged so as to be stacked on the second battery cell positioned at the other end on the opposite side to said one end of said second battery block in the direction in which said plurality of second battery cells of said second battery block are stacked, wherein
said plurality of first battery cells of said first battery block are integrally fixed by being sandwiched between said first end surface member and said third end surface member, and
said plurality of second battery cells of said second battery block are integrally fixed by being sandwiched between said second end surface member and said fourth end surface member.

8. The battery system according to claim 7, wherein
a thickness of said third end surface member is larger than a thickness of said first end surface member, and a thickness of said fourth end surface member is larger than a thickness of said second end surface member.

9. The battery system according to claim 7, further comprising a casing that accommodates said first and second battery blocks, wherein
said third and fourth end surface members are fixed to said casing.

10. An electric vehicle comprising:
the battery system according to claim 1;
a motor driven by electric power supplied from said first battery block and said second battery block of said battery system; and
a drive wheel rotated by a torque generated by said motor.
